(19) United States
(12) Patent Application Publication
(10) Pub. No.: US 2016/0231887 A1
(43) Pub. Date: Aug. 11, 2016

(54) DOCUMENT MANAGEMENT SYSTEM, DOCUMENT REGISTRATION APPARATUS, DOCUMENT REGISTRATION METHOD, AND COMPUTER-READABLE STORAGE MEDIUM

(71) Applicant: CANON KABUSHIKI KAISHA, Tokyo (JP)

(72) Inventor: Manami Hatano, Yokohama-shi (JP)

(21) Appl. No.: 15/015,709

(22) Filed: Feb. 4, 2016

(30) Foreign Application Priority Data
Feb. 9, 2015 (JP) 2015-023717

(51) Int. Cl. G06F 3/0482; H04L 29/08; G06F 17/22; H04N 1/00; G06K 9/00

(52) U.S. Cl. CPC G06F 3/0482; H04N 1/00344; G06K 9/00442; G06F 17/2247; H04L 67/1002

(57) ABSTRACT

Before registering a document with a classification destination selected by a user, the document is analyzed and a classification destination candidate list is generated. The generated classification destination candidate list is compared with the classification destination selected by the user to determine whether a reselection of the classification destination is necessary. If reselection of the classification destination necessary, the classification destination candidate list is presented to the user and reselection of the classification destination is received.

### BACKGROUND

1. Field

Aspects of the present invention generally relate to a document management system for registering, classifying, and managing a document.

2. Description of the Related Art

Among conventional document management systems, there are systems where a document registration application, which is in charge of registering a document, provides the document with a classification for management. Such a system, at the time of document storage, causes a user to select a storage destination, according to the classification, and stores the document into this selected storage destination.

To facilitate the user's selection of the storage destination, Japanese Patent Application Laid-Open No. 2008-234078 discusses a technique that extracts a keyword from document data that is a storage target and presents locations associated with this keyword to the user as candidates for the storage destination.

Further, Japanese Patent Application Laid-Open No. 2013-025700 discusses that, when the candidate for the storage destination is displayed, information such as an update frequency and a reference frequency of this storage destination is also displayed.

As described above, according to the techniques discussed in Japanese Patent Application Laid-Open No. 2008-234078 and Japanese Patent Application Laid-Open No 2013-025700, the user's selection of the storage destination among the candidates for the storage destination immediately leads to a conclusive determination of the storage destination where the data will be stored. In other words, even if the user inadvertently selects another storage destination by performing an erroneous operation when selecting the storage destination, the data is stored into this selected storage destination.

### SUMMARY

According to an aspect of the present invention, a document management system includes a document registration apparatus, a document analysis server, and a document management server. The document registration apparatus includes a first list reception unit configured to receive a first classification destination candidate list generated based on information regarding a user, a first selection reception unit configured to present the first classification destination, candidate list received by the first list reception unit to the user and receive a selection of a classification destination made by the user from the presented first classification destination candidate list, a first transmission unit configured to transmit a registration target document to the document analysis server, a second list reception unit configured to receive a second classification destination candidate list generated by the document analysis server based on an analysis of the registration target document, a determination unit configured to determine whether a reselection of the selected classification destination is necessary by comparing the classification destination received by the first selection reception unit and the second classification destination candidate list received by the second list reception unit, a second selection reception unit configured to present the second classification destination candidate list to the user and receive the reselection of the classification destination made by the user if the determination unit determines that the reselection of the classification destination is necessary, and a second transmission unit configured to transmit the registration target document to the document management server to register the registration target document with the classification destination received by the second selection reception unit. The document analysis server includes a second classification destination candidate list generation unit configured to analyze the registration target document transmitted by the first transmission unit and generate the second classification destination candidate list based on a result of the analysis. The document management server includes a registration unit configured to register the registration target document transmitted by the second transmission unit with the classification destination received by the second selection reception unit.

Further features of aspects of the present invention will become apparent from the following description of exemplary embodiments with reference to the attached drawings.

### BRIEF DESCRIPTION OF THE DRAWINGS

FIG. 1 illustrates an example of a configuration of a document management system.

FIG. 2 illustrates an example of an internal configuration of an image forming apparatus.

FIG. 3 illustrates an example of a hardware configuration of an information processing apparatus that functions as a document classification management server or a document analysis server.

FIG. 4 illustrates an example of an internal software configuration of the document classification management server according to an exemplary embodiment.

FIG. 5 illustrates an example of an internal software configuration of the document analysis server according to the exemplary embodiment.

FIG. 6 is a flowchart illustrating processing by which the document analysis server retrieves and analyzes information about registered documents stored in the document classification management server.

FIG. 7 illustrates an example of an internal software configuration of a document registration application.

FIG. 8, consisting of FIGS. 8A and 8B, is a flowchart illustrating processing performed when a document is registered in the document management system according to a first exemplary embodiment.

FIGS. 9A, 9B, 90, and 9D each illustrate an example of a screen of the document registration application according to the first exemplary embodiment.

FIG. 10 illustrates an example of a screen of the document registration application according to a second exemplary embodiment.

FIG. 11 is a flowchart illustrating processing performed when the document is registered in the second exemplary embodiment.

FIG. 12 illustrates an example of an internal software configuration of the document analysis server according to a third exemplary embodiment.

FIG. 13 illustrates an example of an internal software configuration of the document registration application according to the third, fourth, and fifth exemplary embodiments.

FIG. 14, consisting of FIGS. 11A and 11B, is a flowchart illustrating processing performed when the document is registered in the third exemplary embodiment.

FIG. 15 illustrates an example of an internal software configuration of the document analysis server according to the fourth exemplary embodiment.

FIG. 16 is a flowchart illustrating processing performed when the document is registered in the fourth exemplary embodiment.

FIG. 17 illustrates an example of a configuration of the document management system according to the fifth exemplary embodiment.

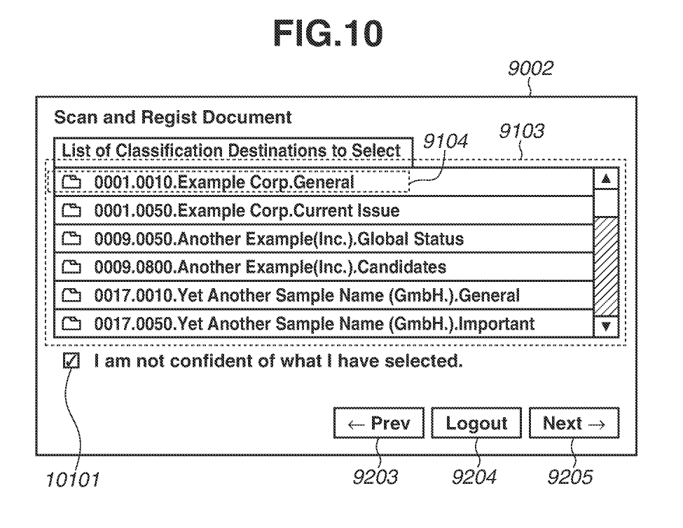

FIG. 10 illustrates an example of an internal software configuration of the document analysis server according to the fifth exemplary embodiment.

FIG. 19 illustrates an example of an internal software configuration of a schedule management server according to the fifth exemplary embodiment.

FIG. 20 is a flowchart illustrating processing performed when the document is registered according to the fifth exemplary embodiment.

### DESCRIPTION OF THE EMBODIMENTS

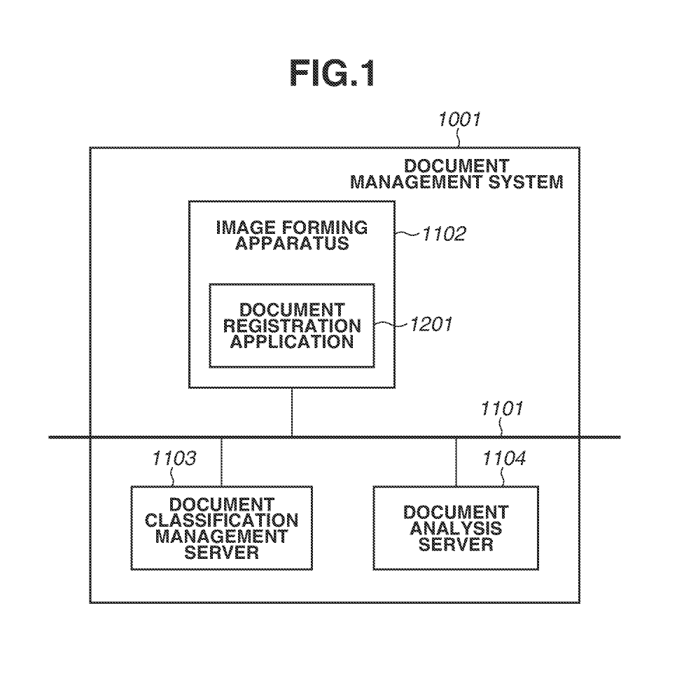

In the following description, a first exemplary embodiment will be described. FIG. 1 illustrates a configuration of a document management system 1001 according to the present exemplary embodiment. A network 1101 is a local area network (LAN), a wide area network (WAN), or the like. The document management system 1001 includes an image forming apparatus (a multifunctional peripheral having a scan function, or a scanner) 1102, a document classification management server (a document management server) 1103, and a document analysis server 1104. Further, a document registration application 1201 is a program to be executed by a central processing unit (CPU) of the image forming apparatus 1102.

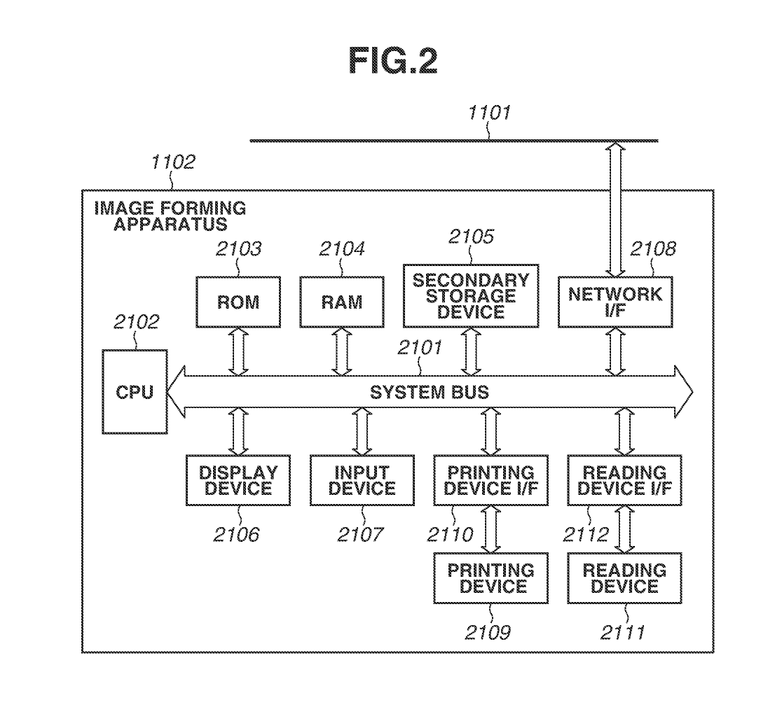

FIG. 2 illustrates an example of an internal configuration of the image forming apparatus (a document registration apparatus) 1102. The image forming apparatus 1102 includes a system bus 2101, a central processing unit (CPU) 2102, a read only memory (ROM) 2103, a readable and writeable memory (a random access memory (RAM)) 2104, a secondary storage device 2105, a display device 2106, an input device 2107, and a network interface (hereinafter, an “interface” will be abbreviated as an “I/F”) 2108. This image forming apparatus 1102 is connected to the network 1101 via the network I/F 2108. The image forming apparatus 1102 further includes a printing device (a printing unit) 2109, a printing device I/F 2110, a reading device (a scanner unit) 2111 that provides a function of scanning a document, and a reading device I/F 2112.

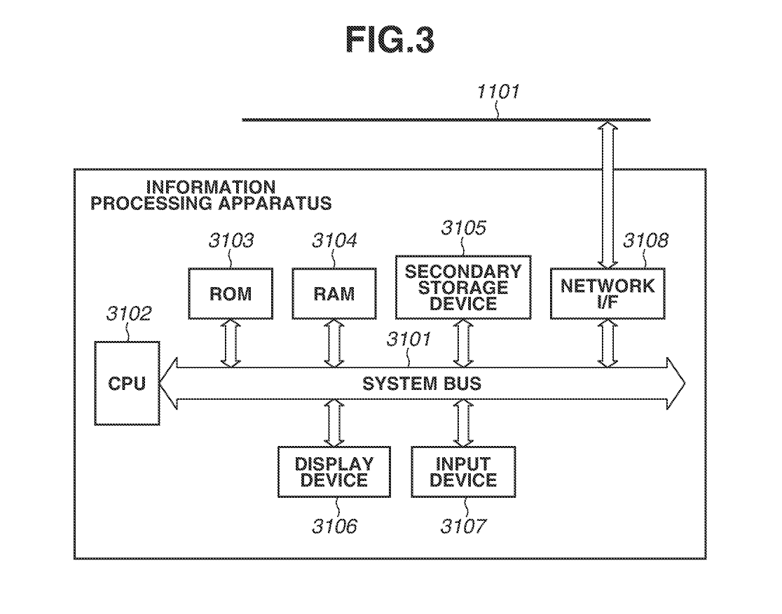

FIG. 3 illustrates an example of a hardware configuration of an information processing apparatus that functions as the document classification management server 1103 or the document analysis server 1104. The information processing apparatus includes a system bus 3101, a CPU 3102, a ROM 3103, a RAN 3104, a secondary storage device 3105, a display device 3106, an input device 3107, and a network I/F 3108. The information processing apparatus is connected to the network 1101 via the network I/F 3108.

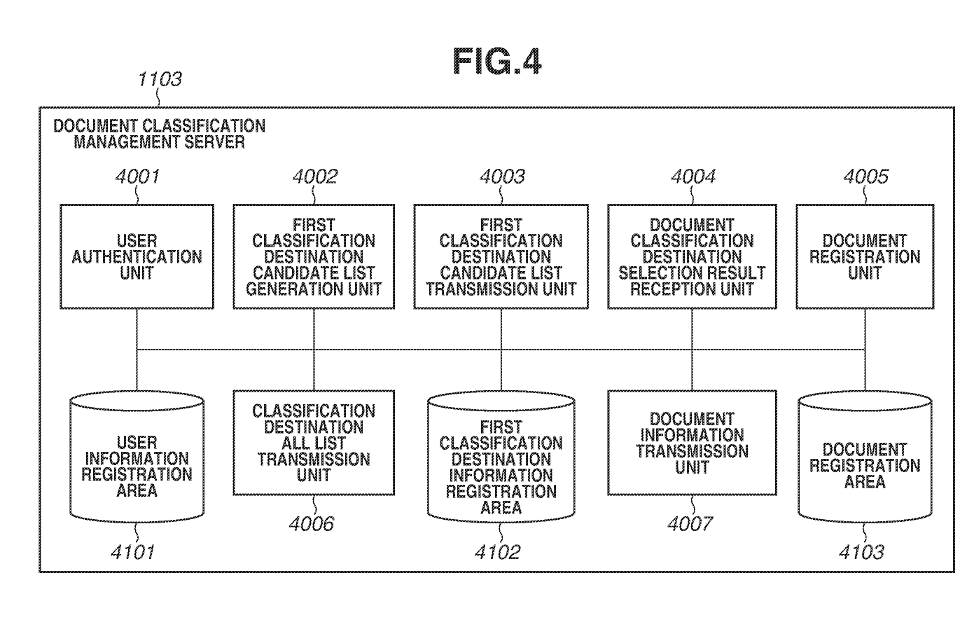

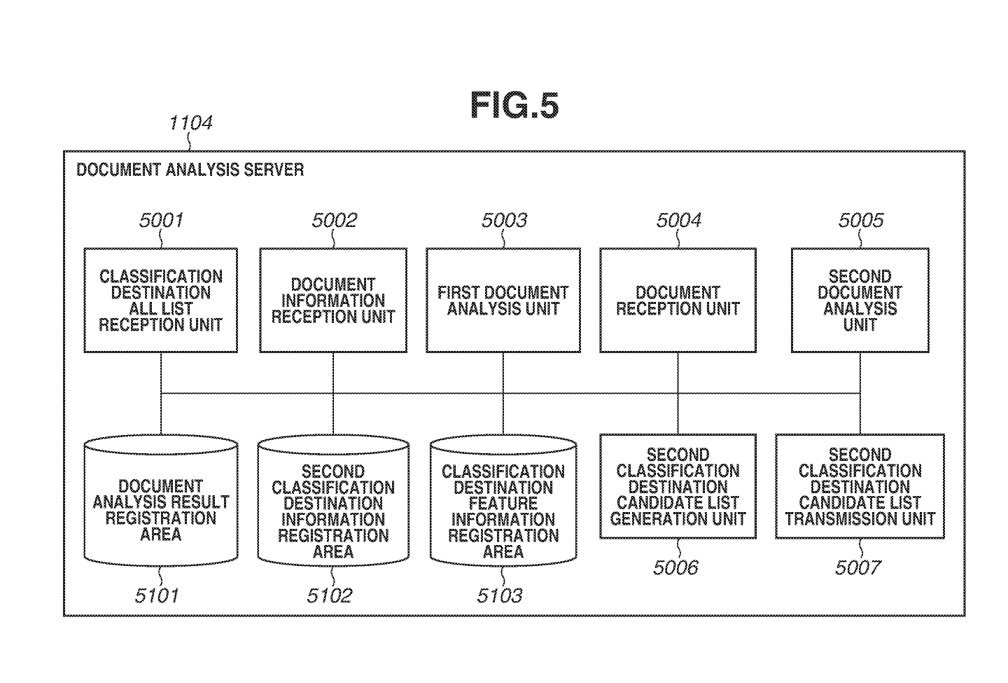

FIG. 4 illustrates an example of a software configuration of the document classification management server 1103 according to the first exemplary embodiment. The CPU 3102 (a computer) of the document classification management server 1103 executes a computer program relating to the present exemplary embodiment, thereby functioning as each of processing units illustrated in FIG. 4.

Identification information of a person using the system (a user), history information indicating documents registered by this user thus far, and history information indicating classification destinations employed for these documents are registered in a user information registration area 4101. Classification destinations as which documents generated thus far are classified, and information appendant thereto are registered in a first classification destination information registration area 4102. The documents registered thus far, information indicating the classification destinations assigned to these documents, and information appendant thereto are registered in a document registration area 4103.

A user authentication unit 4001 receives user authentication information transmitted via the network 1101 to authenticate the user, and transmits a result thereof. A first classification destination candidate list generation unit 4002 generates a first classification destination candidate list with respect to the user authenticated by this user authentication. The first classification destination candidate list is a list that associates information about the user (user information) with a candidate or candidates for the classification destination that is or are determined to be highly likely to be selected when this user registers a document. For example, the first classification destination candidate list generation unit 4002 can fulfill this function by generating the first classification destination candidate list based on the history information registered in the user information registration area 4101 according to a predetermined criterion, such as a classification destination selected by the user recently and a classification destination frequently used by a department that the user belongs to.

A first classification destination candidate list transmission unit 4003 transmits the above-described first classification destination candidate list. A document classification destination selection result reception unit 4004 receives a document and a result of a selection of the classification destination selected for this document from the image forming apparatus 1102 via the network 1101. A document registration unit 4005 registers the document received by the document classification destination selection result reception unit 4004 according to this received result of the selection of the classification destination.

A classification destination all list transmission unit 4006 transmits a list of all pieces of information about the classification destinations registered in the first classification destination information registration area 4102. A document information transmission unit 4007 transmits the information about the documents registered in the document registration area 4103 as necessary.

FIG. 5 illustrates an example of a software configuration of the document analysis server 1104 according to the first exemplary embodiment. The CPU 3102 (a computer) of the document analysis server 1104 executes a computer program relating to the present exemplary embodiment, thereby functioning as each of processing units illustrated in FIG. 5.

Results of analyses of documents received thus far, and information appendant thereto are registered in a document analysis result registration area 5101. The information contained in the list of all of the classification destinations that is acquired from the document classification management server 1103 is registered in a second classification destination information registration area 5102. The documents retrieved from the document classification management server 1103, the information about the classification destinations assigned thereto, and information appendant thereto are registered in a classification destination feature information registration area 5103.

A classification destination all list reception unit 5001 receives the list of all of the classification destinations from the document classification management server 1103, and registers the received list into the second classification destination information registration area 5102.

A document information reception unit 5002 receives the information about the documents from the document classification management server 1103. A first document analysis unit 5003 analyzes the information about the documents received by the document information reception unit 5002.

A document reception unit 5004 receives the document from the document registration application 1201. A second document analysis unit 5005 analyzes a content of the document received by the document reception unit 5004.

A second classification destination candidate list generation unit 5006 generates a second classification destination candidate list with respect to this document. The second classification destination candidate list includes a classification destination or classification destinations each determined to be a highly likely candidate as the classification destination as which this document will be classified based on a result of the analysis of the document. A second classification destination candidate list transmission unit 5007 transmits the second classification destination candidate list to the document registration application 1201.

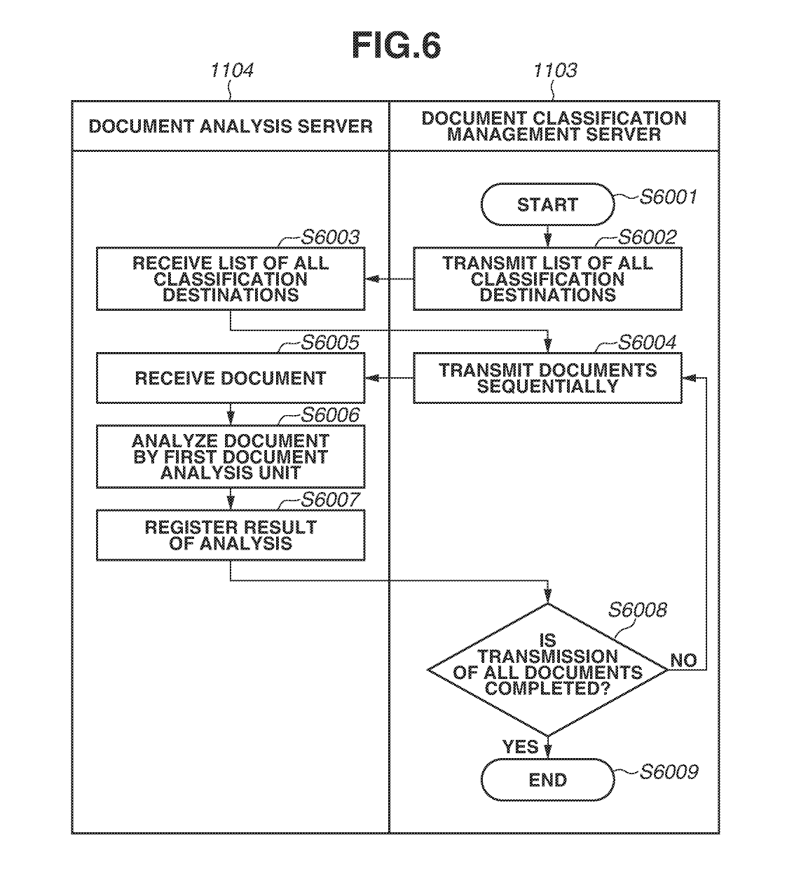

FIG. 6 is a flowchart illustrating a procedure by which the document analysis server 1104 according to the first exemplary embodiment receives and analyzes the data regarding all of the documents classified (managed) by the document classification management server 1103. In step S6001, the processing is started.

In step S6002, first, the classification destination all list transmission unit 4006 of the document classification management server 1103 transmits the list of all of the classification destinations (the information regarding the classification destinations) registered in the first classification destination information registration area 4102 to the document analysis server 1104.

In step S6003, the classification destination all list reception unit 5001 of the document analysis server 1104 receives the list of all of the classification destinations from the document classification management server 1103. The received list of all of the classification destinations is registered into the second classification destination information registration area 5102.

In step S6004, the document information transmission unit 4007 of the document classification management server 1103 sequentially transmits the document data classified as each of the classification destinations, and the information appendant thereto.

In step S6005, the document information, reception unit 5002 of the document analysis server 1104 receives the document data and the information appendant thereto transmitted in step S6004.

In step S6006, the first document analysis unit 5003 of the document analysis server 1104 analyzes this received document and the classification destination that this document belongs to. In this analysis, as one possible method therefor, the first document analysis unit 5003 can perform analysis processing by a method such as an analysis of a morpheme in the document, weighting by extraction of an important word, an analysis of a frequently-appearing word, and statistic processing for acquiring a distribution of a distance between important words, but the analysis method is not limited thereto. A feature amount of this received document is measured by any of these analyses. Then, a coefficient for calculating a degree of fit is corrected with respect to the classification destination that this document belongs to with use of a result thereof. This processing corrects the coefficient for calculating the degree of fit with respect to each of the classification destinations into a coefficient reflecting the feature amount of the document that should be stored in each of the classification destinations.

In step S6007, various kinds of feature amounts of the document analyzed by the first document analysis unit 5003, this corrected coefficient for calculating the degree of fit with respect to the classification destination, and the like are registered into the classification destination feature information registration area 5103.

In step S6008, the document classification management server 1103 checks whether the transmission of all of the documents registered in the document registration area 4103 is completed. If the transmission is not completed (NO in step S6008), the processing returns to step S6004 and continues if the transmission is completed (YES in step S6008), the processing proceeds to step S6009 and is ended.

The document analysis server 1104 can hold the information about the documents and the information regarding the classification destinations therefor managed by the document classification management server 1103 by performing the processing illustrated in FIG. 6. In other words, the document analysis server 1104 can accumulate the information indicating the results of the analyses carried out regarding these documents and the classification destinations therefor.

In the present exemplary embodiment, for example, the processing illustrated in FIG. 6 is assumed to be scheduled for midnight and performed once a day, but is not limited to this configuration. For example, the processing illustrated in FIG. 6 can also be scheduled so as to be performed at a shorter time interval. Further, the processing illustrated in FIG. 6 can also be configured to be performed each time a new document is registered with the document classification management server 1103.

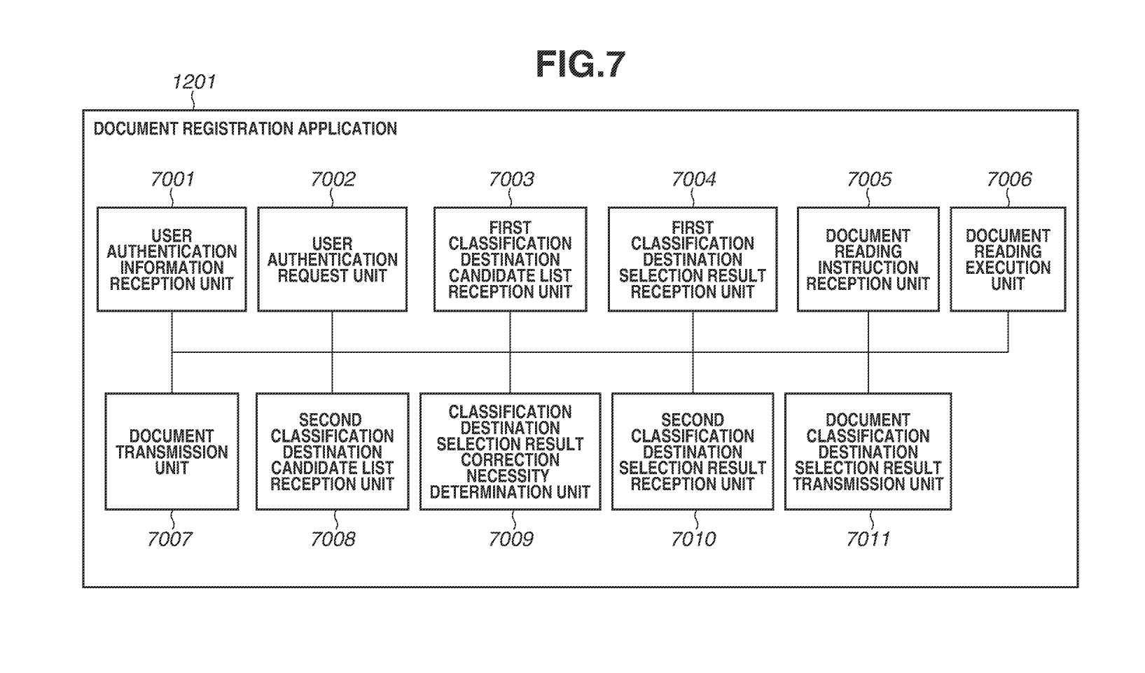

FIG. 7 illustrates an example of a software configuration of the document registration application 1201 according to the first exemplary embodiment. The CPU 2102 of the image forming apparatus 1102 executes the program of the document registration application 1201, thereby functioning as each of units that will be described below. In other words, the image forming apparatus 1102 executing the document registration application 1201 functions as the document registration apparatus.

A user authentication information reception unit 7001 receives the user authentication information input by the user with use of the display device 2106 and the input device 2107.

A user authentication request unit 7002 transmits the authentication information of the person using the system (the user) that is received by the user authentication information reception unit 7001 to the document classification management server 1103 to request authentication, and receives a result of this authentication.

A first classification destination candidate list reception unit 7003 receives the first classification destination candidate list generated based on the information about the user from the document classification management server 1013. A first classification destination selection result reception unit 7004 presents the first classification destination candidate list on the display device 2106, and receives a selection made by the user via the input device 2107.

A document reading instruction reception unit 7005 receives, from the user, an instruction to read a document set on the reading device 2111 by the user via the input device 2107. Then, a document reading execution unit 7006 performs reading processing in response to the instruction to read the document. A document transmission unit 7007 transmits the read document to the document analysis server 1104.

A second classification destination candidate list reception unit 7008 receives the second classification destination candidate list generated with respect to this document from the document analysis server 1104.

A classification destination selection result correction necessity determination unit 7009 compares the classification destination selected by the user and the second classification destination candidate list to determine whether the image forming apparatus 1102 should request the user to correct the result of the selection of the classification destination.

A second classification destination selection result reception unit 7010 receives a correction of the selection from the user, if the image forming apparatus 1102 is determined to have to request the user to correct the result of the selection of the classification destination. At this time, the document registration application 1201 presents the classification destination selected by the user and the second classification destination candidate list on the display device 2106, and receives the correction made by the user via the input device 2107.

A document classification destination selection result transmission unit 7011 transmits the present document, the classification destination, and other appendant information to the document classification management server 1103.

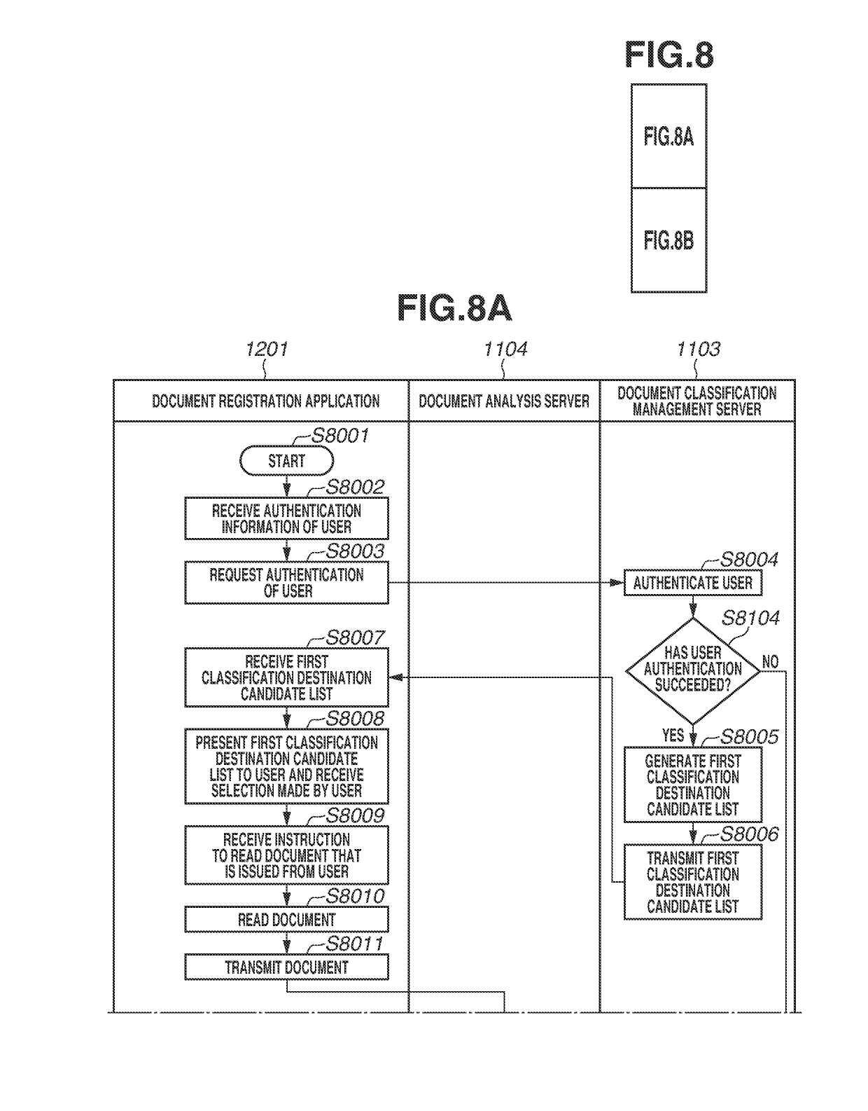

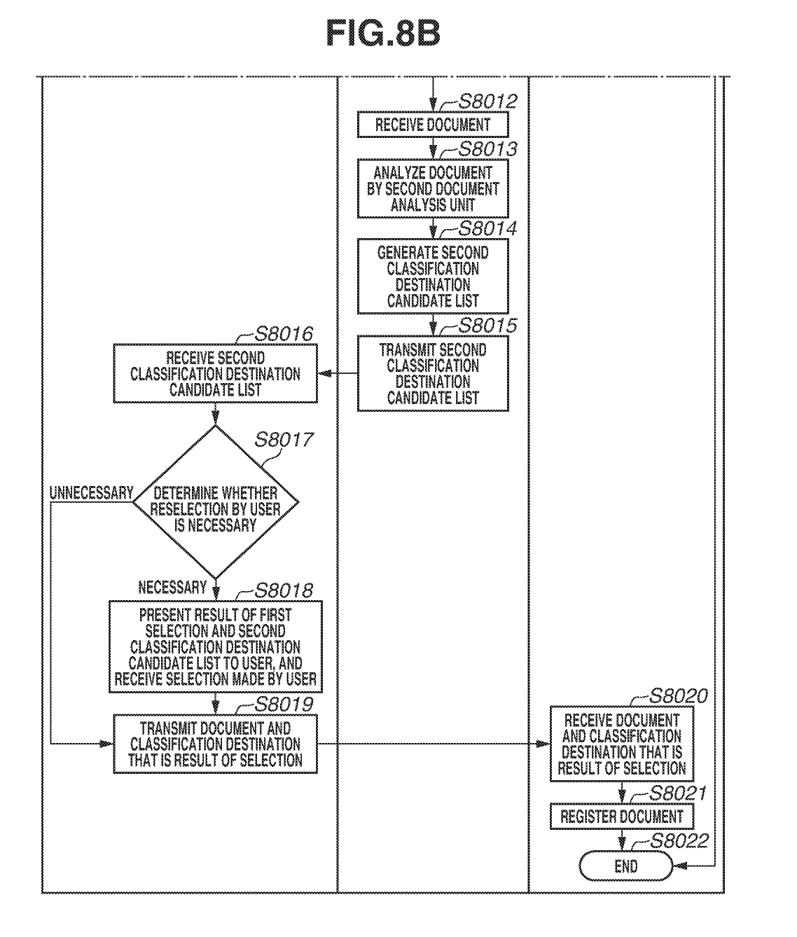

FIG. 8 (consisting of FIGS. 8A and 8B) is a flowchart illustrating a procedure performed when the document management system 1001 according to the first exemplary embodiment registers a document that is a new registration target with the document classification management server 1103 thereof. In step S8001, the processing is started.

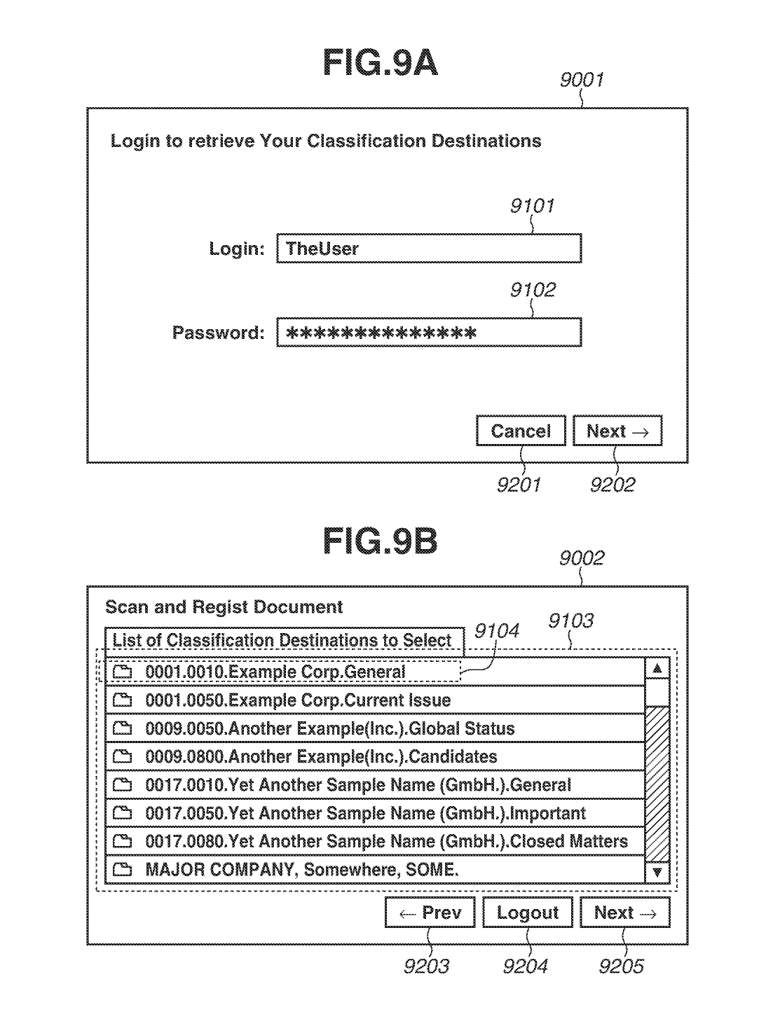

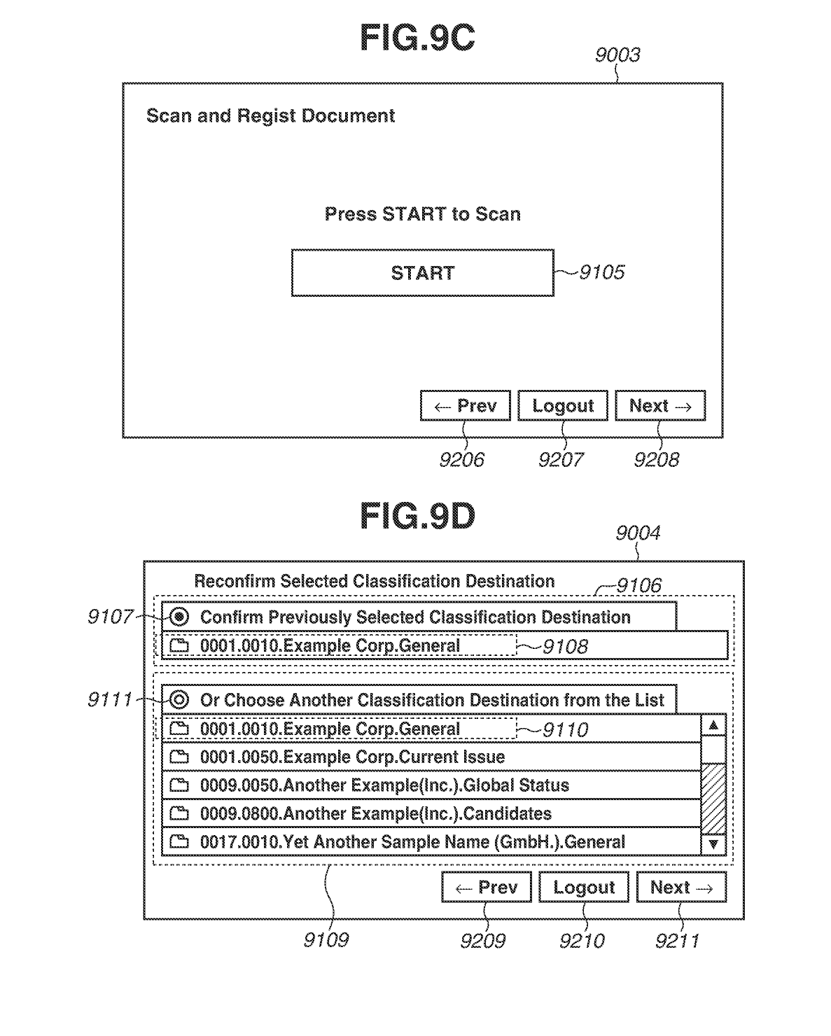

In step S8002, the user authentication information reception unit 7001 of the document registration application 1201 receives the authentication information of the user via the input device 2107. FIG. 9A illustrates an example of a user authentication screen 9001 displayed on the display device 2106 of the image forming apparatus 1102 at this time. The display device 2106 of the image forming apparatus 1102 is assumed to be accompanied by the input device 2107 configured as a touch panel. A name for identifying the user is input by the user into a username input field 9101. A password used to prove that this user is the user himself/herself indicated by the name input in the username input field 9101 is input by the user into a password input field 9102. If a cancel button 9201 is pressed, the document registration application 1201 cancels the reception of the authentication information of the user.

A button 9202 for proceeding to a next screen becomes able to be pressed in a state in which the inputs have been made in the username input field 9101 and the password input field 9102. The button 9202 becomes unable to be pressed when any one of the fields 9101 and 9102 lacks the input and is left blank.

If the button 9202 is pressed in a state of being able to be pressed, the document registration application 1201 completes the reception of the user authentication information. Then, in step S8003, the user authentication request unit 7002 requests the document classification management server 1103 to authenticate the user.

In step S8004, upon receiving the request to authenticate the user, the user authentication unit 4001 of the document classification management server 1103 performs processing for authenticating the user. In step S8104, the document classification management server 1103 determines whether the authentication of the user has succeeded. If the document classification management server 1103 determines that the authentication has failed (NO in step S8104), the processing proceeds to step S8022. Then, the document classification management server 1103 notifies the document registration application 1201 of the failure in the authentication. Then, the processing is ended. If the document classification management server 1103 determines that the authentication has succeeded (YES in step S8104), the processing proceeds to step S8005.

In step S8005, the first classification destination candidate list generation unit 4002 acquires the information regarding the user successfully authenticated by this authentication, from the user information registration area 4101. The first classification destination candidate list generation unit 4002 extracts the classification destination(s) determined to be highly likely to be selected by this user from the first classification destination information registration area 4102 based on this acquired information, and generates the first classification destination candidate list including this or these extracted classification destination(s).

In step S8006, the first classification destination candidate list transmission unit 4003 transmits this generated first classification destination candidate list to the document registration application 1201.

In step S8007, the first classification destination candidate list reception unit 7003 of the document registration application 1201 receives the first classification destination candidate list transmitted from the document classification management server 1103.

In step S8008, the first classification destination selection result reception unit 7005 presents this received first classification destination candidate list via the display device 2106. Then, the first classification destination selection result reception unit 7005 prompts the user to select the classification destination, and receives the result of the selection made by the user via the input device 2107. FIG. 9B illustrates one example of a classification destination selection screen 9002 displayed on the display device 2106 at this time. A classification destination candidate list display section 9103 is prepared as a display component in the form of a list box. A character string displayed in each of elements 9104 of the list is the name of the classification destination contained in the first classification destination candidate list. The name(s) of the single classification destination or the plurality of classification destinations contained in the first classification destination candidate list is or are displayed as the list in this list box group. If the size of the classification destination selection screen 9002 is not sufficient, a scroll bar is displayed at a right edge, which allows the user to scroll the list box to retrieve a name of a classification destination displayed outside the display region onto the display region.

A button 9203 is a button for returning to the previous screen. If the user presses this button 9203, the screen returns to the screen immediately before the current screen (the user authentication screen 9001).

A button 9204 is a button for logging out. If the user presses this button 9204, the image forming apparatus 1102 performs logout processing, and the screen returns to an initial screen.

A button 9205 is a button for proceeding to a next screen. When one classification destination is selected from the name(s) of the classification destination(s) displayed in the classification destination candidate list display section 9103, this button 9205 can be pressed. When no classification destination is selected, this button 9205 becomes unable to be pressed. If the user presses this button 9205 when the button 9205 is in a state of being able to be pressed, the selection of the classification destination is completed, and the document registration application 1201 receives this selection. Then, the screen is switched to a document reading execution instruction screen 9003.

In step S8009, the document reading instruction reception unit 7005 displays the document reading execution instruction screen 9003, and receives the instruction to read the document from the user via the input device 2107. FIG. 9C illustrates an example of the document reading execution instruction screen 9003 displayed on the display device 2106 at this time. A document reading execution instruction button 9105 becomes able to be pressed, when a document is set on the reading device 2111 of the image forming apparatus 1102. The document reading execution instruction button 9105 becomes unable to be pressed, when no document is set. If the user presses this button 9105 after placing the registration target document on the reading device 2111, the reading device 2111 starts reading the document.

A button 9206 is a button for returning to the previous screen. If the user presses this button 9206, the screen returns to the classification destination selection screen 9002.

A button 9207 is a button for logging out if the user presses this button 9207, the image forming apparatus 1102 performs the logout processing, and the screen returns to the initial screen.

A button 9208 is a button for proceeding to a next screen. Similarly to the document reading execution instruction, button 9105, the button 9208 becomes able to be pressed when the registration target document is set on the reading device 2111 by the user, and becomes unable to be pressed when no document is set on the reading device 2111. Then, if the user presses this button 9105 when this button 9105 is in a state of being able to be pressed, the reading device 2111 starts reading the document. Then, in step S8010, the document reading execution unit 7006 reads the new registration target document by the reading device 2111.

In step S8011, the document transmission unit 7007 transmits the document read by the reading unit 2111 in step S8010 to the document analysis server 1104.

In step S8012, the document reception unit 5004 of the document analysis server 1104 receives this transmitted document.

In step S8013, the second document analysis unit 5005 of the document analysis server 1104 calculates a feature amount of the document by analyzing this received document. Then, for each of the classification destinations acquired from the second classification destination information registration area 5102, the degree of fit is calculated with respect to each of the classification destinations multiplication of this calculated feature amount of the document by the coefficient for calculating the degree of fit with respect to this classification destination that is retrieved from the classification destination feature information registration area 5103. A classification destination determined to have a higher degree of fit than a predetermined threshold value is determined to be a highly likely candidate for the classification destination with respect to this document.

In step S8014, the second classification destination candidate list generation unit 5006 of the document analysis server 1104 registers the information about the classification destination determined to have a high degree of fit for this document into the document analysis result registration area 5101. Then, the second classification destination candidate list generation unit 5006 generates the second classification destination candidate list including the classification destination(s) (each) determined to be a highly likely candidate as the classification destination.

Upon the completion of the generation, in step S8015, the document analysis server 1104 transmits this generated second classification destination candidate list to the document registration application 1201.

In step S8016, the second classification destination candidate list reception unit 7008 of the document registration application 1201 receives this transmitted second classification destination candidate list.

In step S8017, the classification destination selection result correction necessity determination unit 7009 compares the classification destination selected by the user in step S8008 and the second classification destination candidate list received in step S8016 to determine whether a reselection of the classification destination by the user is necessary. At this time, if the classification destination selected by the user in step S8008 is not at all contained in the second classification destination candidate list or holds a lower position in the order than a predetermined position even if being contained in the second classification destination candidate list, the classification destination selection result correction necessity determination unit 7009 determines that the reselection is necessary (NECESSARY in step S8017) because it is highly likely that the user has made a mistake in the selection operation in this case. On the other hand, if the classification destination selected by the user is determined to hold a sufficiently high position in the order among the classification destination(s) contained in the second classification destination candidate list, the classification destination selection result correction necessity determination unit 7009 determines that the reselection is unnecessary (UNNECESSARY in step S8017) if the classification destination selection result correction necessity determination unit 7009 determines that the reselection is unnecessary (UNNECESSARY in step S8017), the processing proceeds to step S8019. If the classification destination selection result correction necessity determination unit 7009 determines that the reselection is necessary (NECESSARY in S8017), the processing proceeds to step S8018.

In step S8018, the second classification destination selection result reception unit 7010 presents the classification destination selected in step S8008 and the list of the classification destination(s) contained in the second classification destination candidate list on the display device 2106. Then, the second classification destination selection result reception unit 7010 receives the reselection of the classification destination based on a users instruction via the input device 2107. FIG. 9D illustrates an example of a second classification destination selection screen 9004 displayed on the display device 2106 of the image forming apparatus 1102 at this time.

A name 9108 of the classification destination selected by the user in step S8008 is displayed in a classification destination selection result display section 9106. A radio button 9107 is a button for correcting the classification destination selected by the user in step S8008 and reselecting the classification destination.

The classification destination(s) contained in the second classification destination candidate list received by the document registration application 1201 in step S8016 is or are displayed in a second classification destination candidate list display section 9109 as a list. The name of each of the classification destination(s) contained in the second classification destination candidate list is displayed in an element 9110 of the list. A radio button 9111 is a button for indicating that the user has reselected the classification destination from the second classification destination candidate list. The radio buttons 9107 and 9111 interlock with each other, and are configured to be mutually exclusively selectable.

If a button 9209 for returning to the previous screen is pressed by the user, the screen returns to the document reading execution instruction screen 9003.

A button 9210 is a button for logging out. If the user presses this button 9210, the image forming apparatus 1102 performs the logout processing, and the screen returns to the initial screen.

When the radio button 9107 is selected, or when the radio button 9111 is selected and, at the same time, any classification destination is selected from the second classification destination candidate list display section 9109, a button 9211 for proceeding to a next screen becomes able to be pressed. On the other hand, when the radio button 9111 is selected but no classification destination is selected from the second classification destination candidate list display section 9109, the button 9211 becomes unable to be pressed. If the user presses this button 9211 when the button 9211 is in a state of being able to be pressed, the selection of the classification destination is completed, and the document registration application 1201 receives this selection.

If the button 9211 for proceeding to the next screen is pressed in a state where the radio button 9107 is selected, the classification destination selected by the user in step S8008 is determined to be the finally selected classification destination. If the button 9211 for proceeding to the next screen is pressed in a state where the radio button 9111 is selected and any classification destination selected from the list 9109, the classification destination selected from the second classification destination candidate list display section 9109 is determined to be the finally selected classification destination.

In step S8019, the document classification destination selection result transmission unit 7011 transmits the second classification destination finally selected in step S8018 and the present document to the document classification management server 1103. If the classification destination selection result correction necessity determination unit 7009 determines that the reselection is unnecessary in step S8017 (UNNECESSARY in step S8017), the document classification destination selection result transmission unit 7011 transmits the classification destination selected by the user in step S8008 and the present document.

In step S8020, the document classification destination selection result reception unit 4004 of the document classification management server 1103 receives these transmitted document and classification destination.

In step S8021, the document registration unit 4005 registers this received document with this received classification destination in the document registration area 4103. Then, the processing proceeds to step S8022, and is ended.

In this manner, the document registration application 1201 according to the present exemplary embodiment can present the first classification destination candidate list generated from the user information held by the document classification management server 1103, and allow the user to select the classification destination therefrom, before reading the document.

Then, the document registration application 1201 transmits the document that the user has instructed the image forming apparatus 1102 to read to the document analysis server 1104, and causes the document analysis server 1104 to analyze this document. The document analysis server 1104 generates the second classification destination candidate list based on the results of the analyses performed in advance in the processing described in FIG. 6 and this received document. Then, the document registration application 1201 compares this second classification destination candidate list and the classification destination selected by the user first to determine whether the classification destination selected by the user first should be corrected. Configuring the document management system 1001 in this manner can add a check on whether the classification destination selected by the user first is a classification destination selected due to an erroneous operation.

If determining that the correction is necessary, the document registration application 1201 can request the user to reselect the classification destination. If determining that the correction is unnecessary, the document registration application 1201 omits the reselection of the classification destination. In either case, the present exemplary embodiment can result in registration of the document with the document classification management server 1103 together with the result of the selection of the classification destination that is determined to be appropriate by the user.

In this manner, according to the document management system 1001 of the present exemplary embodiment, after the user selects the classification destination as which the registration target document will be classified, the document registration application 1201 automatically checks whether this selected classification destination is appropriate. Therefore, if determining that it is highly likely that the user has made a mistake in the selection of the classification destination due to an erroneous operation, the document registration application 1201 can present an opportunity to correct this result of the selection to the user. Configuring the document management system 1001 in this manner can reduce occurrence of a document registered with an inappropriate classification destination selected therefor.

Next, a second exemplary embodiment will be described with reference to the drawings. A system configuration diagram of the document management system 1001 according to the second exemplary embodiment is similar to the system configuration diagram illustrated in FIG. 1. An internal configuration of the image forming apparatus 1102 according to the second exemplary embodiment is also similar to the internal configuration illustrated in FIG. 2. Further, an internal configuration of the information processing apparatus where the document classification management server 1103 or the document analysis server 1104 according to the second exemplary embodiment operates is also similar to the internal configuration illustrated in FIG. 3. An internal software configuration of the document classification management server 1103 according to the second exemplary embodiment is similar to internal software the configuration illustrated in FIG. 1. An internal software configuration of the document analysis server 1104 according to the second exemplary embodiment is similar to the internal software configuration illustrated in FIG. 5. Further, a procedure by which the document analysis server 1104 according to the second exemplary embodiment receives and analyzes the data of all of the documents registered with the document classification management server 1103 is similar to the procedure illustrated in FIG. 6. An internal software configuration of the document registration application 1201 according to the second exemplary embodiment is similar to the internal software configuration illustrated in FIG. 7.

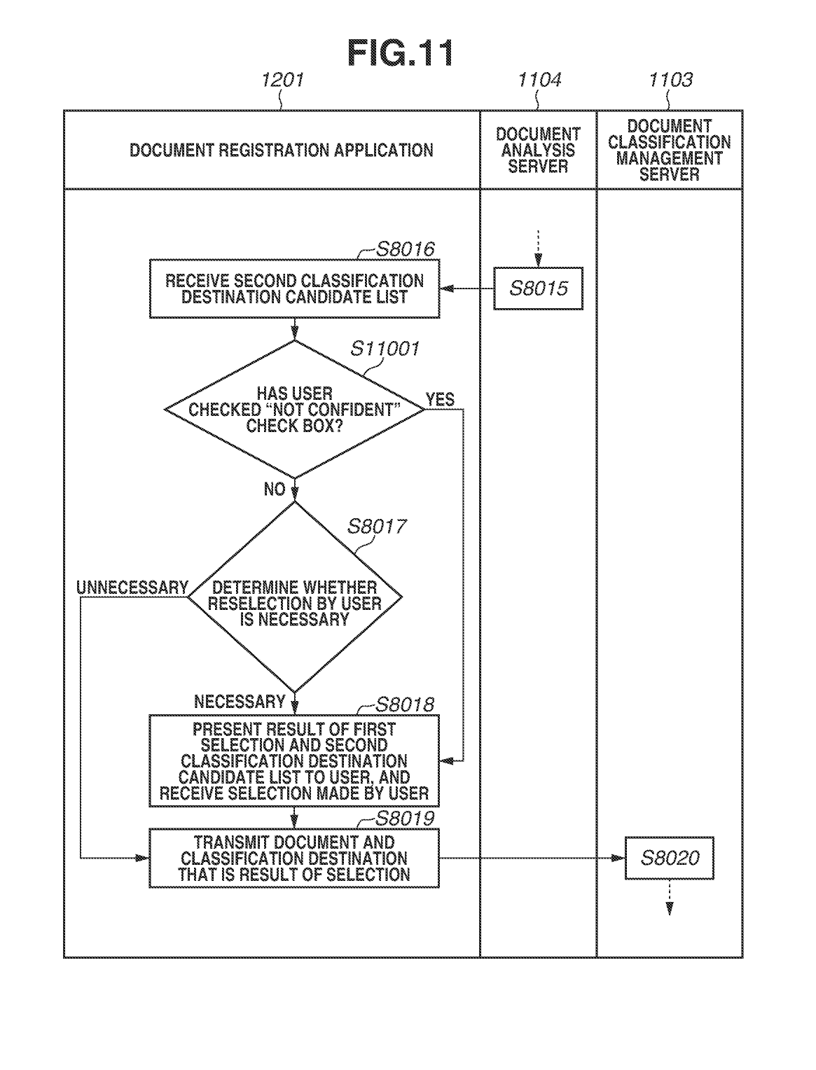

FIG. 11 is a partial flowchart extracted from a flowchart illustrating a procedure by which the document registration application 1201 receives the user's operation to register the document in the second exemplary embodiment, and indicating a difference from FIG. 8. In other words, this flowchart as a whole is similar to the flowchart illustrated in FIG. 8 and steps identified by the same step numbers have similar processing contents to FIG. 8, but a step identified by a different step number from the step numbers illustrated in FIG. 8 has a different processing content from FIG. 8.

FIG. 10 illustrates an example of a screen displayed on the display device 2106 when the document registration application 1201 presents the first classification destination candidate list to the user and prompts the user to select the classification destination therefrom in step S8008 in the second exemplary embodiment. A check box 10101 is used for the user to check whether the user is not confident when selecting the classification destination. This check box 10101 is presented so that the user checks the check box 10101 if, for some reason, being not confident of the selection of the classification destination for the document that the user is about to instruct the image forming apparatus 1102 to read from now. Among components illustrated in FIG. 10, components identified by the same reference numerals as FIG. 9B are similar to FIG. 9B, and therefore descriptions thereof will be omitted here.

In the flowchart of FIG. 11, each of steps until step S8015 is similar to the corresponding step illustrated in FIG. 8.

In step S8016, the second classification destination candidate list reception unit 7008 of the document registration application 1201 receives the second classification destination candidate list. After that, the processing proceeds to step S11001 as a step next thereto in the processing according to the second exemplary embodiment.

In step S11001, the document registration application 1201 determines whether the user has checked the check box 10101 on the screen illustrated in FIG. 10 when selecting the classification destination in step S8008. If the user has checked the check box 10101 in step S11001), the processing proceeds to step S8018. If the user has not checked the check box 10101 (NO in step S11001), the processing proceeds to step S8017.

In step S8017, the classification destination selection result correction necessity determination unit 7009 determines whether the reselection by the user is necessary, similarly to the first exemplary embodiment. If the classification destination selection result correction necessity determination unit 7009 determines that the reselection by the user is necessary (NECESSARY in step S8017), the processing proceeds to step S8018. If the classification destination selection result correction necessity determination unit 7009 determines that the reselection by the user is unnecessary (UNNECESSARY in step S8017), the processing proceeds to step S8019.

In step S8018, the second classification destination selection result reception unit 7010 receives the reselection made by the user, similarly to the first exemplary embodiment.

In step S8019, the document classification destination selection result transmission unit 7011 transmits the document and the selected classification destination to the document classification management server 1103. In step S8020, the document classification destination selection result reception unit 4004 of the document classification management server 1103 receives these document and selected classification destination. A flow thereafter is similar to the flow illustrated in FIG. 8.

In this manner, the second exemplary embodiment provides measures by which, when selecting the classification destination by viewing the first classification destination candidate list, the user can declare that the user is not confident of this selection. As a result, the document registration application 1201 can allow the user to confirm and correct the classification destination with use of the second classification destination candidate list, thereby succeeding in reducing cases in which a less certain classification destination is received without being checked again. Since being configured in this manner, the second exemplary embodiment allows the user to select the classification destination from the second classification destination candidate list generated based on the content of the document if being not confident when selecting the classification destination from the first classification destination candidate list, thereby allowing the user to select the classification destination with less worry.

In other words, according to the second exemplary embodiment, even if the user is unfamiliar with the operation of scanning the document and registering the document with the classification destination, the user can perform this operation with less worry.

Next, a third exemplary embodiment will be described with reference to the drawings. A system configuration diagram of the document management system 1001 according to the third exemplary embodiment is similar to the system configuration diagram illustrated in FIG. 1. An internal configuration of the image forming apparatus 1102 according to the third exemplary embodiment is similar to the internal configuration illustrated in FIG. 2. Further, an internal configuration of the information processing apparatus where the document classification management server 1103 or the document analysis server 1104 according to the third exemplary embodiment operates is similar to the internal configuration illustrated in FIG. 3. An internal software configuration of the document classification management server 1103 according to the third exemplary embodiment is similar to the internal software configuration illustrated in FIG. 4.

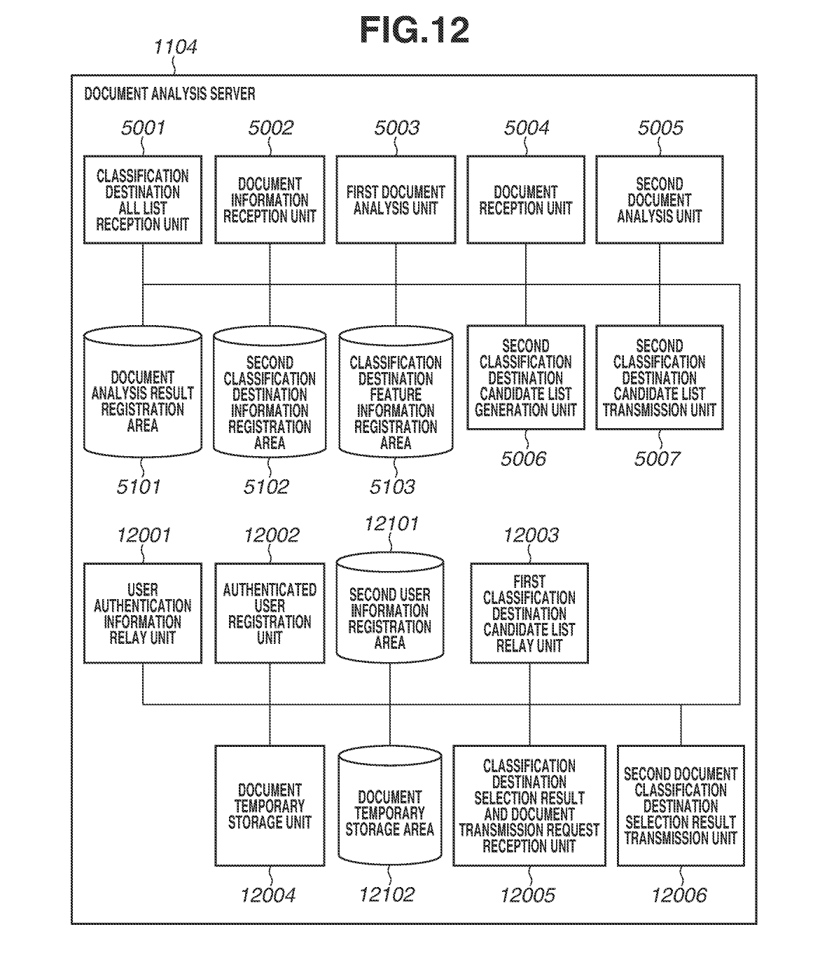

FIG. 12 illustrates an example of an internal software configuration of the document analysis server 1104 according to the third exemplary embodiment. Units identified by the reference numerals shared with FIG. 5 are similar to the units described with reference to FIG. 5, so that only differences from FIG. 5 will be described here.

The document analysis server 1104 according to the third exemplary embodiment includes a user authentication information relay unit 12001.

An authenticated user registration unit 12002 registers the information about the authenticated user. The document analysis server 1104 according to the third exemplary embodiment further includes a second user information registration area 12101.

A first classification destination candidate list relay unit 12003 relays the transmission and the reception of the first classification destination candidate list by receiving and transmitting the first classification destination candidate list.

The document analysis server 1104 according to the third exemplary embodiment further includes a document temporary storage unit 12004, a document temporary storage area 12102, a classification destination selection result and document transmission request reception unit 12005, and a second document classification destination selection result transmission unit 12006.

A procedure by which the document analysis server 1104 according to the third exemplary embodiment receives and analyzes the data of all of the documents registered with the document classification management server 1103 is similar to the procedure illustrated in FIG. 6.

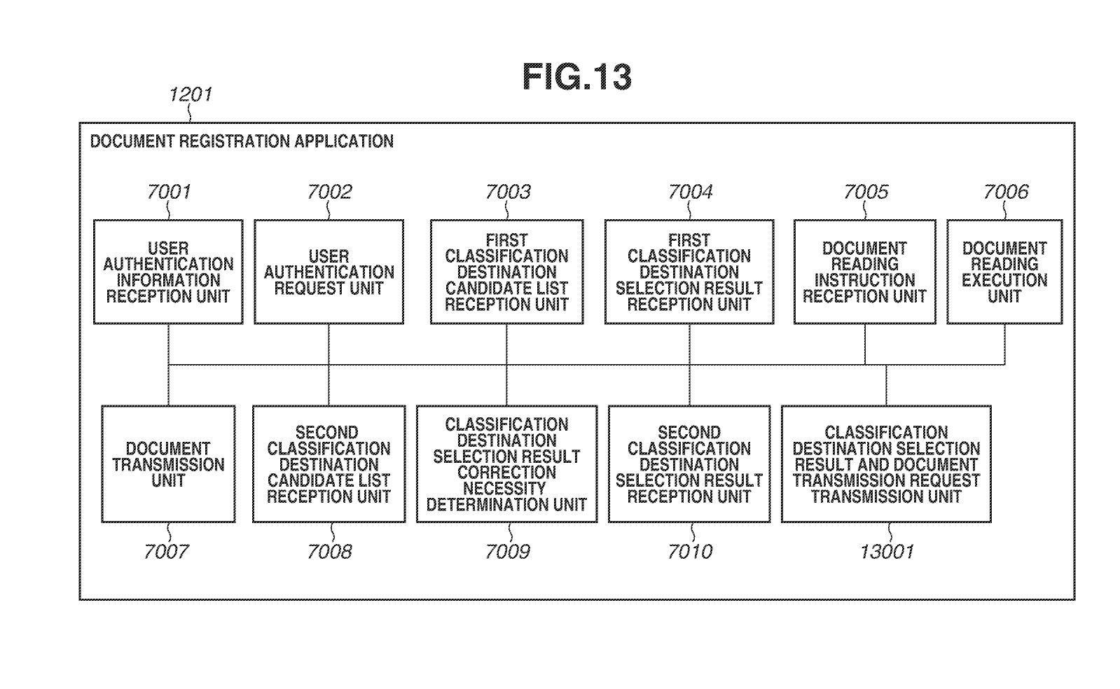

FIG. 13 illustrates an example of an internal software configuration of the document registration application 1201 according to the third exemplary embodiment. The document registration application 1201 according to the third exemplary embodiment includes a classification destination selection result and document transmission request transmission unit 13001. Units identified by the reference numerals shared with FIG. 7 are similar to the units described with reference to FIG. 7.

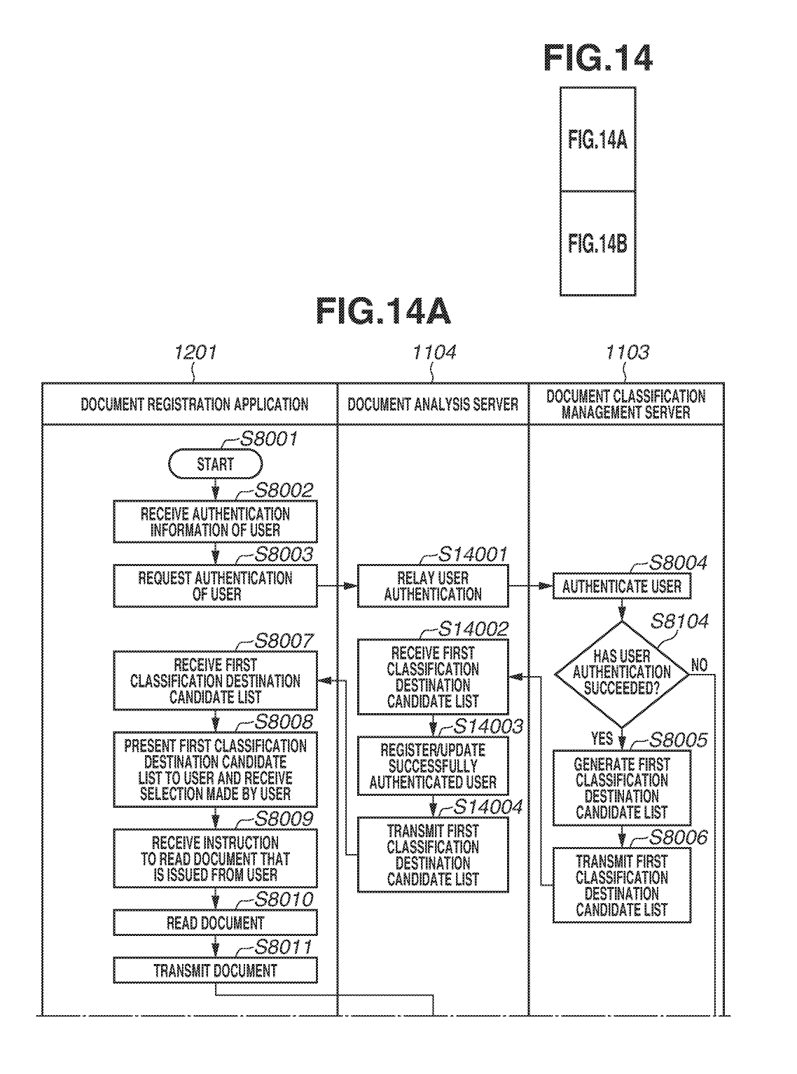

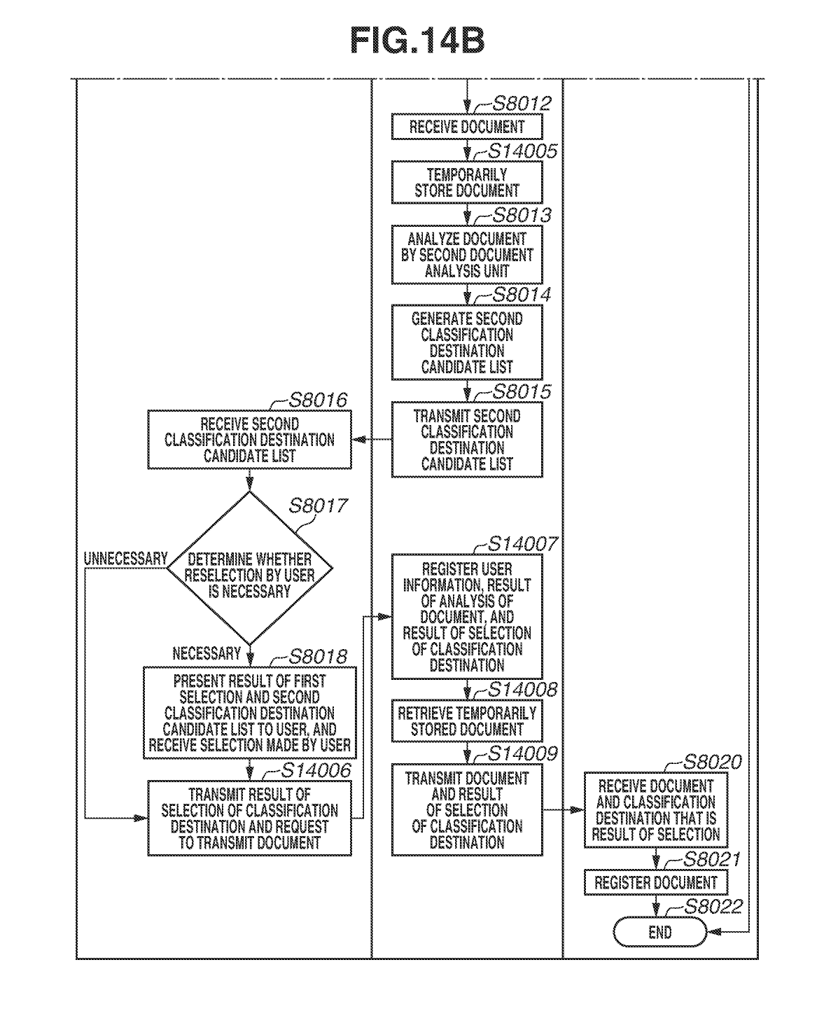

FIG. 14 (consisting of FIGS. 14A and 14B) is a flowchart illustrating a flow until the document is read and registered in the third exemplary embodiment. In the following description, only differences from FIG. 8 will be described.

In step S8003, the user authentication request unit 7002 of the document registration application 1201 transmits the request to authenticate the user to the document analysis server 1104.

In step S14001, the document analysis server 1104 receives the user authentication requested by the document registration application 1201, and relays this user authentication to the document classification management server 1103. Then, in step S8004, the document classification management server 1103 receives the authentication request, and authenticates the user by the user authentication unit 4001.

If the authentication has succeeded in step S8104 (YES in step S8104), the document classification management server 1103 generates the first classification destination candidate list based on the user information. Then, in step S8006, the document classification management server 1103 transmits the first classification destination candidate list. Then, in step S14002, the first classification destination candidate list relay unit 12003 of the document analysis server 1104 receives this first classification destination candidate list.

In step S14003, the document analysis server 1104 can detect that the request to authenticate the user has succeeded from the transmission of the first classification destination candidate list to the document analysis server 1104. Upon this detection, the document analysis server 1104 updates or newly registers the information about this user into the second user information registration area 12101 by referring to the present user authentication information.

In step S14004, the first classification destination candidate list relay unit 12003 transmits the received first classification destination candidate list to the document registration application 1201. In step S8007, the first classification destination candidate list reception unit 700 of the document registration application 1201 receives this transmitted first classification destination candidate list. Then, the processing continues in the manner described with reference to FIG. 8.

Further, when the document analysis server 1104 receives the document in step S8012, the processing proceeds to step S14005. In step S14005, the document temporary storage unit 12004 stores this received document into the document temporary storage area 12102. Then, the processing proceeds to step S8013, and continues.

Further, if the document registration application 1201 determines that the image forming apparatus 1102 does not have to request the user to reselect the classification destination in step S8017 (UNNECESSARY in step S8017), or if the document registration application 1201 receives the reselection of the classification destination that is made by the user in step S8018, the processing proceeds to step S14006. In step S14006, the classification destination selection result and document transmission request transmission unit 13001 transmits the information indicating the classification destination selected by the user and the request to transmit the document to the document analysis server 1104.

In step S14007, the classification destination selection result and document transmission request reception unit 12005 receives this information indicating the classification destination and this request to transmit the document. Then, the classification destination selection result and document transmission request reception unit 12005 stores this information into the second user information registration area 12101 together with the user authentication information relayed in step S14001.

In step S14008, the second document classification destination selection result transmission unit 12006 retrieves the document stored in the document temporary storage area 12102. In step S14009, the second document classification destination selection result transmission unit 12006 transmits this retrieved document to the document classification management server 1103 together with the classification destination that is the result of the selection of the classification destination, which has been received in step S14007. In step S8020, the document classification destination selection result reception unit 4004 receives these pieces of information. The processing thereafter proceeds in a similar manner to the processing described with reference to FIG. 8.

In this manner, according to the third exemplary embodiment, the document management system 1001 can acquire such an advantage that the document registration application 1201 only has to communicate just with the document analysis server 1104 any time. As a result, the document registration application 1201 becomes usable in the same manner as before even when the document classification management server 1103 is replaced with another server apparatus, requiring a change in a communication procedure and the like. This can bring about such an advantage that the document registration application 1201 that should be prepared can be limited to only a single application from the user's point of view. Therefore, the document management system 1001 according to the third exemplary embodiment can also acquire such an advantage that the user only has to learn how to use such a document registration application 1201 just once.

Further, the document registration application 1201 according to each of the first and second exemplary embodiments is configured to transmit the document read in step S8010 to the document analysis server 1104 in step S8011, and also transmit this document to the document classification management server 1103 in step S8019. On the other hand, the document registration application 1201 according to the third exemplary embodiment only has to transmit the document to the document analysis server 1104 once, which can reduce a communication amount and a processing time spent by the document registration application 1201.

The third exemplary embodiment uses the configuration additional to the first exemplary embodiment, but this additional configuration can also be used for the second exemplary embodiment in a similar manner.

A fourth exemplary embodiment will be described with reference to the drawings. A system configuration diagram of the document management system 1001 according to the fourth exemplary embodiment is similar to the system configuration diagram illustrated in FIG. 1. An internal configuration of the image forming apparatus 1102 according to the fourth exemplary embodiment is also similar to the internal configuration illustrated in FIG. 2. Further, an internal configuration of the information processing apparatus where the document classification management server 1103 or the document analysis server 1104 according to the fourth exemplary embodiment operates is also similar to the internal configuration illustrated in FIG. 3. An internal software configuration of the document classification management server 1103 according to the fourth exemplary embodiment is similar to the internal software configuration illustrated in FIG. 4.

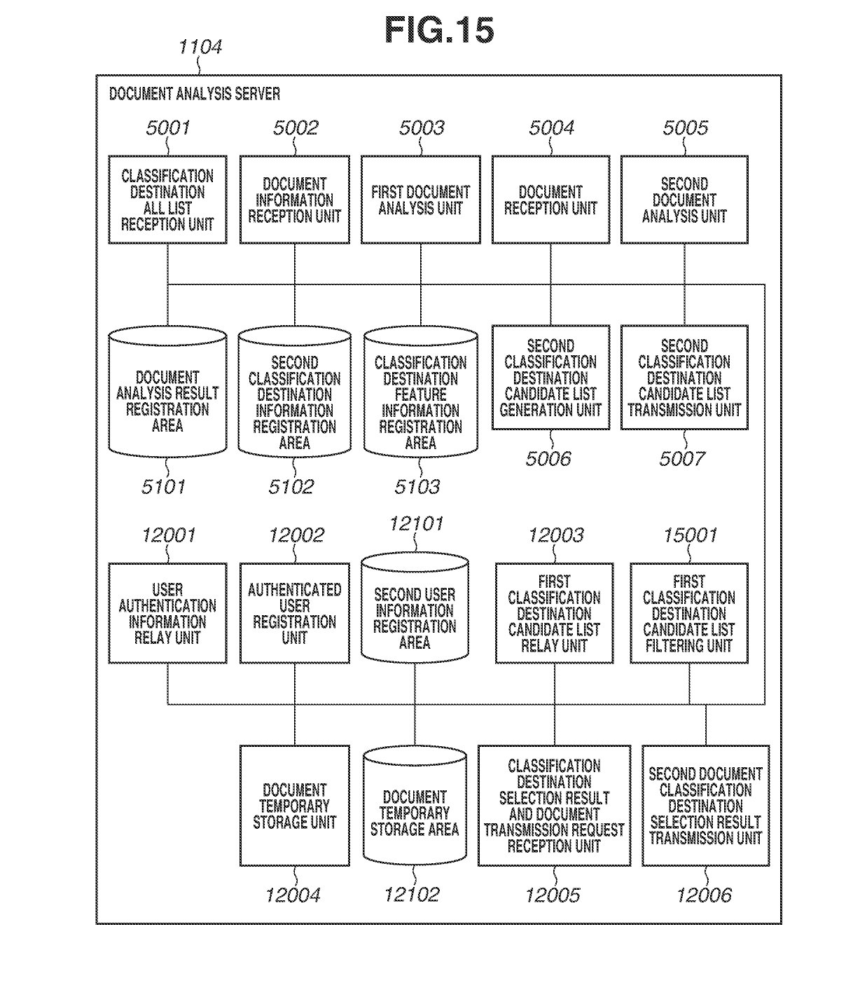

FIG. 15 briefly illustrates an internal software configuration of the document analysis server 1104 according to the fourth exemplary embodiment. A first classification destination candidate list filtering unit 15001 serves to filter the first classification destination candidate list. Units identified by the reference numerals shared with FIG. 5 or 12 are similar to the units described with reference to FIG. 5 or 12.

Further, a procedure by which the document analysis server 1104 according to the fourth exemplary embodiment receives and analyzes the data of all of the documents registered with the document classification management server 1103 is similar to the procedure illustrated in FIG. 6. An internal software configuration of the document registration application 1201 according to the fourth exemplary embodiment is also similar to the internal software configuration illustrated in FIG. 13.

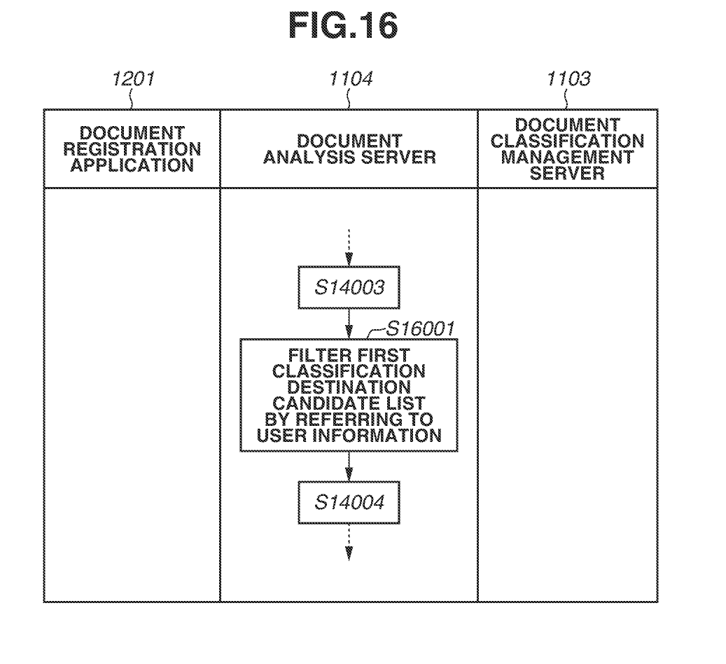

FIG. 16 is a flowchart illustrating a flow until the document is read and registered in the fourth exemplary embodiment in the following description, only differences from FIGS. 8 and 14 will be described.

In step S14003, the first classification destination candidate list relay unit 12003 receives the first classification destination candidate list. After that, the processing proceeds to step S16001.

In step S16001, the first classification destination candidate list filtering unit 15001 filters the first classification destination candidate list by referring to the second user information registration area 12101. The filtering is carried out, for example, in the form of a removal of a classification destination determined to be relatively less likely to be selected by the user as the classification destination with which the user will register the document from the first classification destination candidate list. Such a determination can be made based on information such as presence of a past record indicating that this user has not selected a specific classification destination for a predetermined time period.

As a result, the first classification destination candidate list is transmitted in step S14004 with use of the first classification destination candidate list that is a result of filtering this list. Having received that, the document registration application 1201 displays this filtered first classification destination candidate list in the classification destination candidate list display section 9103 illustrated in FIG. 9B.

In this manner, according to the fourth exemplary embodiment, when presenting the first classification destination candidate list to the user, the document management system 1001 can use the information regarding this user that is accumulated by the document analysis server 1104. This results in elimination of a display of an unnecessary option contained in the first classification destination candidate list. Therefore, the document management system 1001 can further reduce the possibility that an inappropriate classification destination selected when the document is registered.

Subsequently, a fifth exemplary embodiment will be described with reference to the drawings.

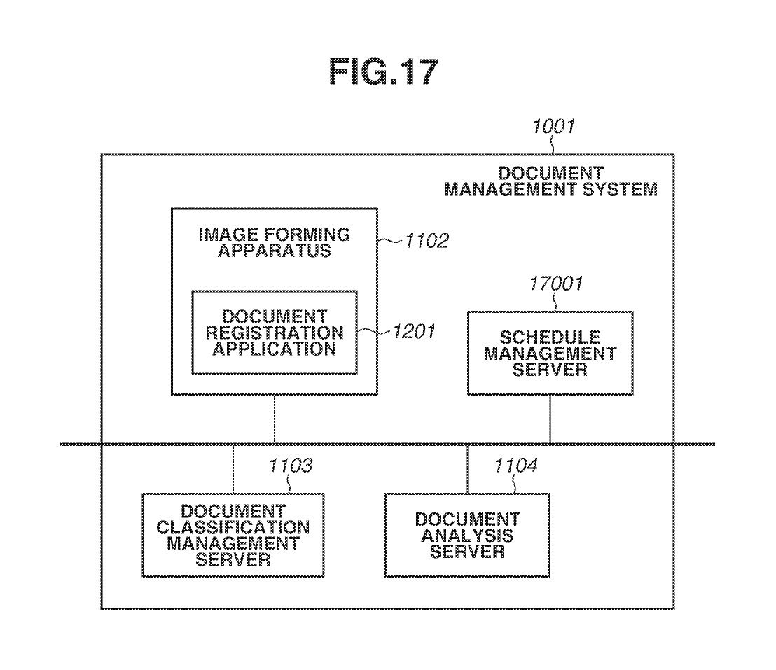

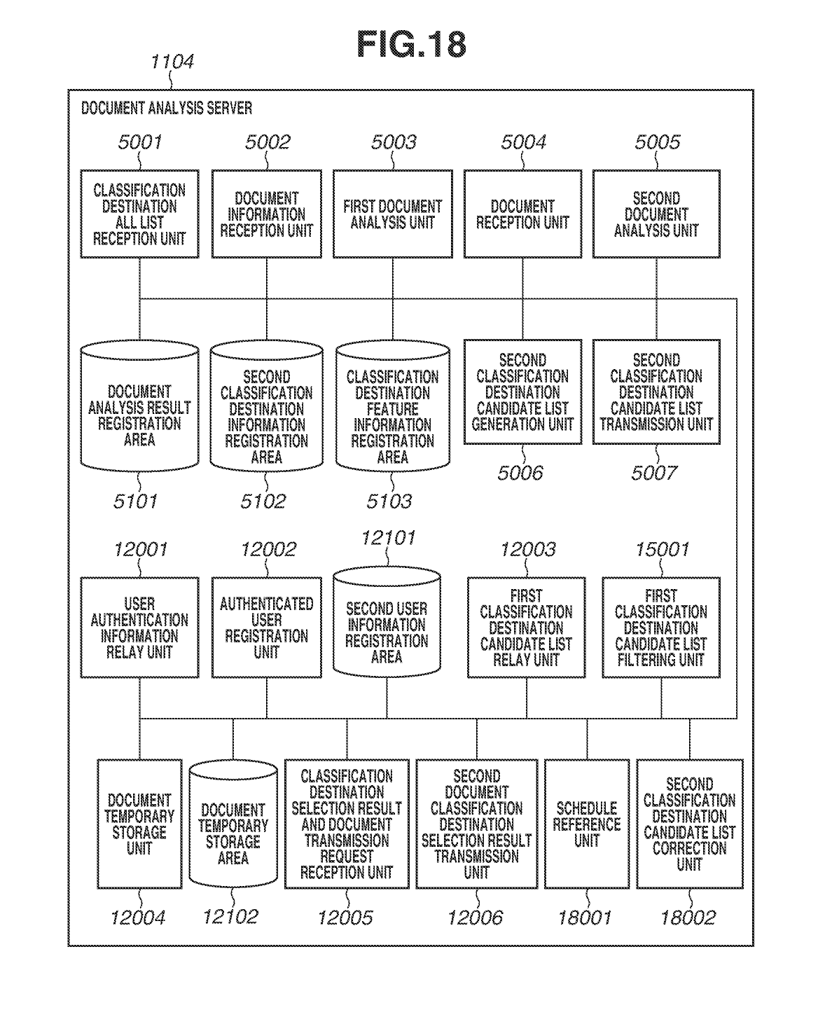

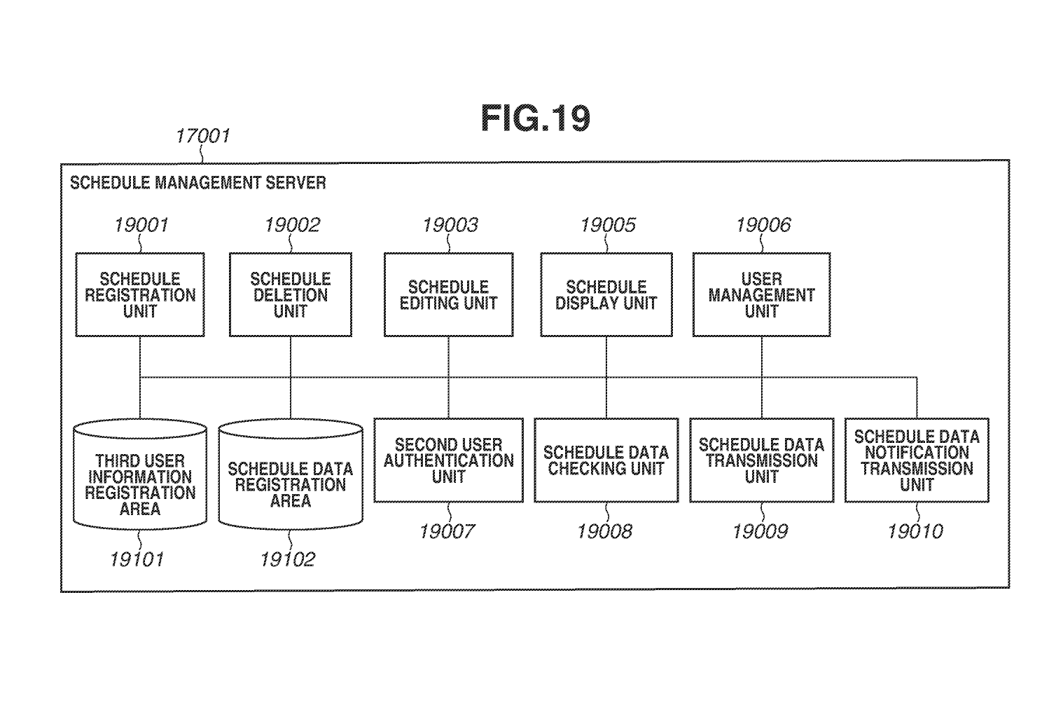

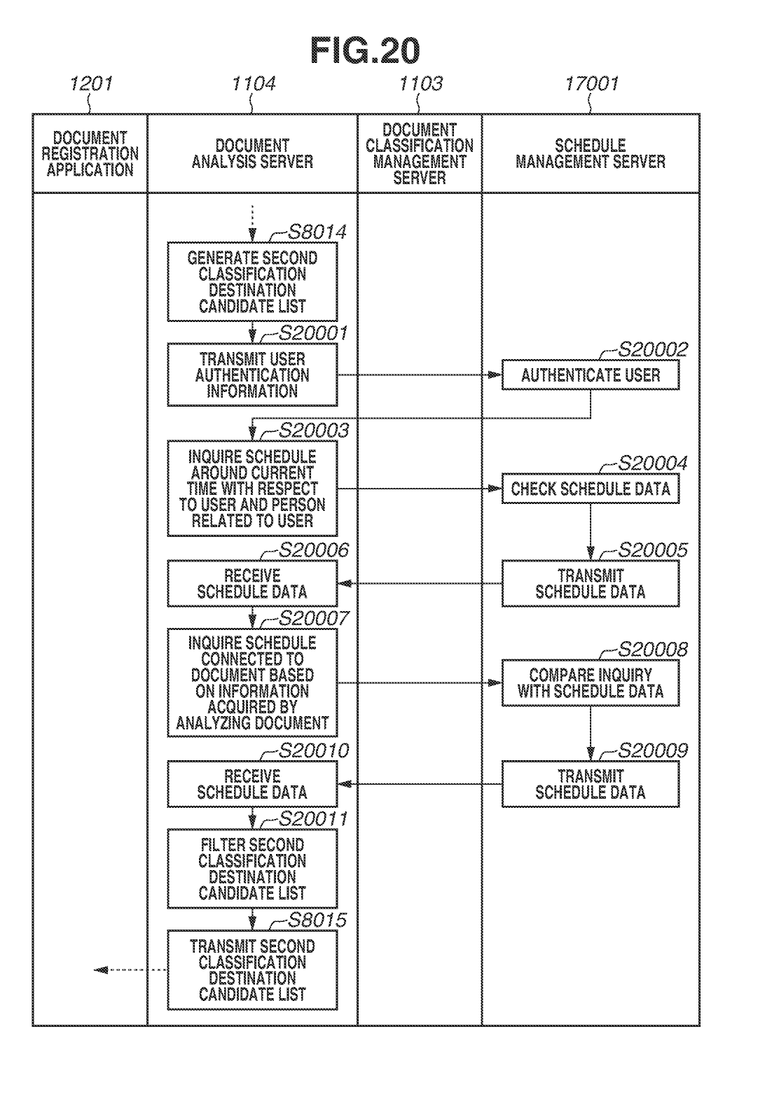

FIG. 17 briefly illustrates a system configuration of the document management system 1001 according to the fifth exemplary embodiment. A schedule management server 17001 serves to manage an action plan of the user or each member of a group that the user belongs. Units identified by the reference numerals shared with FIG. 1 are similar to the units described with reference to FIG. 1.

Further, an internal configuration of the image forming apparatus 1102 according to the fifth exemplary embodiment is similar to the internal configuration illustrated in FIG. 2. An internal configuration of the information processing apparatus where the document classification management server 1103, the document analysis server 1104, or the schedule management server 17001 according to the fifth exemplary embodiment operates is similar to the internal configuration illustrated in FIG. 3.

FIG. 18 illustrates an example of an internal configuration of the document analysis server 1104 according to the fifth exemplary embodiment. Units identified by the reference numerals shared with FIG. 5, 12, or 15 are similar to the units described with reference to each of FIGS. 5, 12, and 15. In the following description, only differences therefrom will be described.

The document analysis server 1104 according to the fifth exemplary embodiment includes a schedule reference unit 18001. A second classification destination candidate list correction unit 18002 serves to remove a candidate from the second classification destination candidate list or change a position of a candidate in the order with use of schedule data acquired from the schedule management server 17001.

Further, a procedure by which the document analysis server 1104 according to the fifth exemplary embodiment receives and analyzes the data of all of the documents registered with the document classification management server 1103 is similar to the procedure illustrated in FIG. 6.

Further, an internal software configuration of the document registration application 1201 according to the fifth exemplary embodiment is similar to the internal software configuration illustrated in FIG. 13.

FIG. 19 briefly illustrates an internal software configuration of the schedule management server 17001 according to the fifth exemplary embodiment.

User information of the schedule management server 17001 is registered in a third user information registration area 19101. Schedule data managed by the schedule management server 17001 is registered in a schedule data registration area 19102.

A schedule registration unit 19001 receives and registers a schedule input by the user. A schedule deletion unit 19002 receives a user's instruction to delete the registered schedule. A schedule editing unit 19003 can rewrite a content of the registered schedule by presenting the currently registered schedule to the user and receiving an instruction to change the content. A schedule display unit 19005 presents the currently registered schedule to the user. The schedule registration unit 19001, the schedule deletion unit 19002, the schedule editing unit 19003, and the schedule display unit 19005 are accompanied by a screen that allows the user to operate them. In the present example, these units 19001, 19002, 19003, and 19005 are assumed to be configured according to implementation of commonly employed schedule management, and a description of the screen will be omitted herein.

A user management unit 19006 manages the user of this schedule management server 17001 together with the user authentication information thereof. The user management unit 19006 is accompanied by a screen for receiving a management operation input by the user. However, a content thereof is assumed to be configured according to implementation of a commonly employed method for managing users, and a description of the screen will be omitted herein.

A second user authentication unit 19007 serves to authenticate the user of the schedule management server 17001.

A schedule data checking unit 19008 receives an inquiry regarding the schedule data via the network 1101, and extracts the schedule data that matches this inquiry from the schedule data registration area 19102.

A schedule data transmission unit 19009 transmits the schedule data.

A schedule notification transmission unit 19010 issues a notification at a scheduled notification time registered in the schedule data registration area 19102. One example of possible implementation of the schedule notification transmission unit 19010 is to issue the notification with use of an electronic mail in the present example, the schedule notification transmission unit 19010 is assumed to be configured according to the implementation of the notification by these commonly used systems that manage the schedule, and a specific procedure, such as a procedure for transmitting the notification via the electronic mail, will not be described herein.

FIG. 20 is a flowchart illustrating a procedure for registering the document in the document management system 1001 according to the fifth exemplary embodiment. In the following description, only differences from FIGS. 8, 14, and 16 will be described.

In step S8014, the document analysis server 1104 generates the second classification destination candidate list. After that, the processing proceeds to step S20001 in the fifth exemplary embodiment.

In step S20001, the user authentication information relay unit 12001 transmits the user authentication information to the schedule management server 17001 by referring to the second user information registration area 12101.

In step S20002, the second user authentication unit 19007 receives the user authentication information and authenticates the user. If the authentication has succeeded, the processing proceeds to step S20003.

In step S20003, the schedule reference unit 18001 of the document analysis server 1104 generates a checking condition for inquiring the schedule around the current time with respect to the user and a person related to the user, and transmits the generated checking condition to the schedule management server 17001. In the present example, a possible individual regarded as the person related to the user is, for example, a supervisor, a subordinate, or a member working in the same team in a company organization, but the person related to the user is not limited thereto.

In step S20004, the schedule data checking unit 19008 receives the inquiry based on this received checking condition, and checks the schedule data. In step S20005, the schedule data transmission unit 19009 transmits the schedule data that is a result of the checking to the document analysis server 1104.

In step S20006, the schedule reference unit 18001 receives the schedule data. Then, in step S20007, the schedule reference unit 18001 generates a checking condition for inquiring the schedule based on the information acquired as a result of the analysis of the document, and transmits the generated checking condition to the schedule management server 17001. One example of possible implementation therefor is to, if the result of the analysis of the document contains a proper name that seems like a personal name or a name of an organization, inquire regarding that. This configuration allows the document analysis server 1104 to extract the schedule that seems like strongly connected to the currently analyzed document. If presence of such a schedule is found out, the classification destination as which the document will be classified is highly likely to be set to a classification destination strongly associated with this information.

In step S20008, the schedule checking unit 19008 of the schedule management server 17001 checks the schedule data against this inquiry. In step S20009, the schedule data transmission unit 19009 transmits the schedule data that is a result of this checking to the document analysis server 1104.

In step S20011, the second classification destination candidate list correction unit 18002 filters the present second classification destination candidate list with use of the schedule data received in steps S20006 and S20010. Then, the processing proceeds to step S8015.

In step S8015, the second classification destination candidate list transmission unit 5007 transmits the second classification destination candidate list to the document registration application 1201. The processing thereafter proceeds in a similar manner to the processing according to the other exemplary embodiments.

According to the fifth exemplary embodiment, the document analysis server 1104 can refer to the schedule data in the schedule management server 17001 with use of the user information and the information acquired as a result of the analysis of the document. Furthermore, referring to such schedule data allows the document analysis server 1104 to determine whether it is highly likely that this document is connected to any action that the user or the person related to the user is involved in. As a result, the document analysis server 1104 can further highly accurately generate the list of the candidates for the classification destination as which this document will be classified. Therefore, the document management system 1001 can further reduce the possibility that an inappropriate classification destination is selected when the document is registered.

### Other Embodiments

Embodiments of the present invention can also be realized by a computer of a system or apparatus that reads out and executes computer executable instructions (e.g., one or more programs) recorded on a storage medium (which may also be referred to more fully as a. ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-023717, filed Feb. 9, 2015, which is hereby incorporated by reference herein in its entirety.

What is claimed is:

1. A document management system comprising:
a document registration apparatus;
a document analysis server; and
a document management server,
wherein the document registration apparatus includes:
a first list reception unit configured to receive a first classification destination candidate list generated based on information regarding a user,
a first selection reception unit configured to present the first classification destination candidate list received by the first list reception unit to the user, and receive a selection of a classification destination made by the user from the presented first classification destination candidate list,
a first transmission unit configured to transmit a registration target document to the document analysis server,
a second list reception unit configured to receive a second classification destination candidate list generated by the document analysis server based on an analysis of the registration target document,
a determination unit configured to determine whether a reselection of the selected classification destination is necessary by comparing the classification destination received by the first selection reception unit and the second classification destination candidate list received by the second list reception unit,
a second selection reception unit configured to present the second classification destination candidate list to the user and receive the reselection of the classification destination made by the user, if the determination unit determines that the reselection of the classification destination is necessary, and
a second transmission unit configured to transmit the registration target document to the document management server to register the registration target document with the classification destination received by the second selection reception unit,
wherein the document analysis server includes a second classification destination candidate list generation unit configured to analyze the registration target document transmitted by the first transmission unit and generate the second classification destination candidate list based on a result of the analysis, and
wherein the document management server includes a registration unit configured to register the registration target document transmitted by the second transmission unit with the classification destination received by the second selection reception unit.

2. The document management system according to claim 1, wherein the document management server further includes a first classification destination candidate list generation unit configured to generate the first classification destination candidate list based on the information regarding the user, and
wherein the first list reception unit of the document registration apparatus receives the first classification destination candidate list generated by the first classification destination candidate list generation unit of the document management server based on the information regarding the user.

3. The document management system according to claim 1, wherein the document analysis server further includes a feature information registration unit configured to receive information about document data classified as each of classification destinations from the document management server, and register information regarding a feature of the document stored in each of the classification destinations based on a result of an analysis of this received information, and
wherein the second classification destination candidate list generation unit analyzes the registration target document transmitted by the first transmission unit, and generates the second classification destination candidate list based on a result of the analysis and the information registered with the feature information registration unit.

4. The document management system according to claim 1, wherein the second transmission unit transmits the registration target document to the document management server to register the registration target document with the classification destination received by the first selection reception unit, if the determination unit determines that the reselection of the classification destination is unnecessary.

5. The document management system according to claim 1, wherein the second selection reception unit of the document registration apparatus presents the second classification destination candidate list to the user and receives the reselection of the classification destination made by the user, if the first selection reception unit, when receiving the selection the classification destination by the user from the first classification destination candidate list, further receives a declaration that the user is not confident of this selection of the classification destination from the user.

6. The document management system according to claim 1, wherein the document analysis server further includes a schedule reference unit configured to refer to schedule data of the user, and
wherein the second classification destination candidate list generation unit analyzes the registration target document transmitted by the first transmission unit, and generates the second classification destination candidate list based on a result of the analysis and the schedule data of the user.

7. A document management system comprising:
a document registration apparatus;
a document analysis server; and
a document management server,
wherein the document registration apparatus includes:
a first list reception unit configured to receive first classification destination candidate list generated based on information regarding a user,
a first selection reception unit configured to present the first classification destination candidate list received by the first list reception unit to the user, and receive a selection of a classification destination made by the user from the presented first classification destination candidate list,
a first transmission unit configured to transmit a registration target document to the document analysis server,
a second list reception unit configured to receive a second classification destination candidate list generated by the document analysis server based on an analysis of the registration target document,
a determination unit configured to determine whether a reselection of the selected classification destination is necessary by comparing the classification destination received by the first selection reception unit and the second classification destination candidate list received by the second list reception unit,
a second selection reception unit configured to present the second classification destination candidate list to the user and receive the reselection of the classification destination made by the user, if the determination unit determines that the reselection of the classification destination is necessary, and
a second transmission unit configured to transmit a request to the document analysis server to register the registration target document with the classification destination received by the second selection reception unit,
wherein the document analysis server includes:
a temporary storage unit configured to temporarily store the registered target document transmitted by the first transmission unit,
a second classification destination candidate list generation unit configured to analyze the registered target document stored in the temporary storage unit and generate the second classification destination candidate list based on a result of the analysis, and
a third transmission unit configured to transmit the registration target document stored in the temporary storage unit to the document management server to register the registration target document with the classification destination received by the second selection reception unit, when the document analysis server receives the request transmitted by the second transmission unit, and
wherein the document management server includes a registration unit configured to register the registration target document transmitted by the third transmission unit with the classification destination received by the second selection reception unit.

8. The document management system according to claim 7, wherein the document management server further includes a first classification destination candidate list generation unit configured to generate the first classification destination candidate list based on the information regarding the user,
wherein the document analysis server further includes a relay unit configured to receive the first classification destination candidate list generated by the first classification destination candidate list generation unit of the document management server based on the information regarding the user, and transmit this received first classification destination candidate list to the document registration apparatus, and
wherein the first list reception unit of the document registration apparatus receives the first classification destination candidate list from the relay unit.

9. The document management system according to claim 8, wherein the relay unit of the document analysis server carries out predetermined filtering on the received first classification destination candidate list, and transmits the first classification destination candidate list filtered by the filtering to the document registration apparatus.

10. The document management system according to claim 7, wherein the document analysis server further includes a schedule reference unit configured to refer to schedule data of the user, and
wherein the second classification destination candidate list generation unit analyzes the registration target document transmitted by the first transmission unit, and generates the second classification destination candidate list based on a result of the analysis and the schedule data of the user.

11. A document registration apparatus connected to a document analysis server and a document management server, the document registration apparatus comprising:
a first list reception unit configured to receive first classification destination candidate list generated based on information regarding a user;
a first selection reception unit configured to present the first classification destination candidate list received by the first list reception unit to the user, and receive a selection of a classification destination made by the user from the presented first classification destination candidate list;
a first transmission unit configured to transmit a registration target document to the document analysis server;
a second list reception unit configured to receive a second classification destination candidate list generated by the document analysis server based on an analysis of the registration target document;
a determination unit configured to determine whether a reselection of the selected classification destination is necessary by comparing the classification destination received by the first selection reception unit and the second classification destination candidate list received by the second list reception unit;
a second selection reception unit configured to present the second classification destination candidate list to the user and receive the reselection of the classification destination made by the user, if the determination unit determines that the reselection of the classification destination is necessary; and
a second transmission unit configured to transmit the registration target document to the document management server to register the registration target document with the classification destination received by the second selection reception unit,
wherein the document analysis server includes a second classification destination candidate list generation unit configured to analyze the registration target document transmitted by the first transmission unit and generate the second classification destination candidate list based on a result of the analysis, and
wherein the document management server includes a registration unit configured to register the registration target document transmitted by the second transmission unit with the classification destination received by the second selection reception unit.

12. A document registration apparatus connected to a document analysis server and a document management server, the document registration apparatus comprising:
a first list reception unit configured to receive a first classification destination candidate list generated based on information regarding a user;
a first selection reception unit configured to present the first classification destination candidate list received by the first list reception unit to the user, and receive a selection of a classification destination made by the user from the presented first classification destination candidate list;
a first transmission unit configured to transmit a registration target document to the document analysis server;
a second list reception unit configured to receive a second classification destination candidate list generated by the document analysis server based on an analysis of the registration target document;
a determination unit configured to determine whether a reselection of the selected classification destination is necessary by comparing the classification destination received by the first selection reception unit and the second classification destination candidate list received by the second list reception unit;
a second selection reception unit configured to present the second classification destination candidate list to the user and receive the reselection of the classification destination made by the user, if the determination unit determines that the reselection of the classification destination is necessary; and
a second transmission unit configured to transmit a request to the document analysis server to register the registration target document with the classification destination received by the second selection reception unit,
wherein the document analysis server includes:
a temporary storage unit configured to temporarily store the registration target document transmitted by the first transmission unit,
a second classification destination candidate list generation unit configured to analyze the registration target document stored in the temporary storage unit and generate the second classification destination candidate list based on a result of the analysis, and
a third transmission unit configured to transmit the registration target document stored in the temporary storage unit to the document management server to register the registration target document with the classification destination received by the second selection reception unit, when the document analysis server receives the request transmitted by the second transmission unit, and
wherein the document management server includes a registration unit configured to register the registration target document transmitted by the third transmission unit with the classification destination received by the second selection reception unit.

13. A document registration method for a document registration apparatus connected to a document analysis server and a document management server, the document registration method comprising:
receiving, as first list reception, a first classification destination candidate list generated based on information regarding a user;
presenting the first classification destination candidate list received by the first list reception to the user and receiving, as first selection reception, a selection of a classification destination made by the user from the presented first classification destination candidate list;
transmitting, as first transmission, a registration target document to the document analysis server;
receiving, as second list reception, a second classification destination candidate list generated by the document analysis server based on an analysis of the registration target document;
determining whether a reselection of the selected classification destination is necessary by comparing the classification destination received by the first selection reception and the second classification destination candidate list received by the second list reception;
presenting the second classification destination candidate list to the user and receiving the reselection of the classification destination made by the user, as second selection reception, if it is determined that the reselection of the classification destination is necessary; and
transmitting, as second transmission, the registration target document to the document management server to register the registration target document with the classification destination received by the second selection reception.

14. A document registration method for a document registration apparatus connected to a document analysis server and a document management server, the document registration method comprising:
receiving, as first list reception, a first classification destination candidate list generated based on information regarding a user;
presenting the first classification destination candidate list received by the first list reception to the user and receiving, as first selection reception, a selection of a classification destination made by the user from the presented first classification destination candidate list;
transmitting, as first transmission, a registration target document to the document analysis server;
receiving, as second list reception, a second classification destination candidate list generated by the document analysis server based on an analysis of the registration target document;
determining whether a reselection of the selected classification destination is necessary by comparing the classification destination received by the first selection reception and the second classification destination candidate list received by the second list reception;
presenting the second classification destination candidate list to the user and receiving the reselection of the classification destination made by the user, as second selection reception, if it is determined by the determination that the reselection of the classification destination is necessary; and
transmitting, as second transmission, a request to the document analysis server to register the registration target document with the classification destination received by the second selection reception.

15. A non-transitory computer-readable medium storing computer executable instructions for controlling a computer to execute a document registration method for a document registration apparatus connected to a document analysis server and a document management server, the document registration method comprising:
receiving, as first list reception, a first classification destination candidate list generated based on information regarding a user;
presenting the first classification destination candidate list received by the first list reception to the user and receiving, as first selection reception, a selection of a classification destination made by the user from the presented first classification destination candidate list;
transmitting, as first transmission, a registration target document to the document analysis server;
receiving, as second list reception, a second classification destination candidate list generated by the document analysis server based on an analysis of the registration target document;
determining whether a reselection of the selected classification destination is necessary by comparing the classification destination received by the first selection reception and the second classification destination candidate list received by the second list reception;
presenting the second classification destination candidate list to the user and receiving the reselection of the classification destination made by the user, as second selection reception, if it is determined that the reselection of the classification destination is necessary; and
transmitting, as second transmission, the registration target document to the document management server to register the registration target document with the classification destination received by the second selection reception.

16. A non-transitory computer-readable medium storing computer executable instructions for controlling a computer to execute a document registration method for a document registration apparatus connected to a document analysis server and a document management server, the document registration method comprising:
receiving, as first list reception, a first classification destination candidate list generated based on information regarding a user;
presenting the first classification destination candidate list received by the first list reception to the user and receiving, as first selection reception, a selection of a classification destination made by the user from the presented first classification destination candidate list;
transmitting, as first transmission, a registration target document to the document analysis server;
receiving, as second list reception, a second classification destination candidate list generated by the document analysis server based on an analysis of the registration target document;
determining whether a reselection of the selected classification destination is necessary by comparing the classification destination received by the first selection reception and the second classification destination candidate list received by the second list reception;
presenting the second classification destination candidate list to the user and receiving the reselection of the classification destination made by the user, as second selection reception, if it is determined by the determination that the reselection of the classification destination is necessary; and
transmitting, as second transmission, a request to the document analysis server to register the registration target document with the classification destination received by the second selection reception.
